(19) United States
(12) Patent Application Publication
(10) Pub. No.: US 2025/0078625 A1
(43) Pub. Date: Mar. 6, 2025

(54) Rate Control of Different Metamorphic Features Activation According to a Triggering Mechanism in a Random Gaming Environment

(71) Applicant: Aristocrat Technologies, Inc., Las Vegas, NV (US)

(72) Inventors: Blake Davis, Las Vegas, NV (US); Allon Englman, Las Vegas, NV (US)

(21) Appl. No.: 18/460,142

(22) Filed: Sep. 1, 2023

(51) Int. Cl. G07F 17/32

(52) U.S. Cl. CPC G07F 17/3267; G07F 17/3213

(57) ABSTRACT

An electronic gaming machine (EGM) includes a processor that achieves a designated RTP by providing a game feature that randomly awards one or more metamorphic feature types within a single spin. Additionally, the game feature that randomly awards one or more metamorphic feature types may be based on a triggering mechanism. The EGM utilizes different weight tables, reel strips, or a combination thereof depending on how the game triggers the game feature. For example, the game may trigger the game feature based on a base game outcome (e.g., 3SCAT, 4SCAT, and/or 5SCAT), a random feature trigger, the buying of an instant feature, or a combination thereof. Based on the triggering mechanism used, the game may have different probabilities in triggering one or more of the metamorphic feature types for a single spin.

### RELATED APPLICATION(S)

N/A

### BACKGROUND

Electronic gaming machines (“EGMs”) or gaming devices provide a variety of wagering games such as slot games, video poker games, video blackjack games, roulette games, video bingo games, keno games and other types of games that are frequently offered at casinos and other locations. Play on EGMs typically involves a player establishing a credit balance by inputting money, or another form of monetary credit, and placing a monetary wager (from the credit balance) on one or more outcomes of an instance (or single play) of a primary or base game. In some cases, a player may qualify for a special mode of the base game, a secondary game, or a bonus round of the base game by attaining a certain winning combination or triggering event in, or related to, the base game, or after the player is randomly awarded the special mode, secondary game, or bonus round. In the special mode, secondary game, or bonus round, the player is given an opportunity to win extra game credits, game tokens or other forms of payout. In the case of “game credits” that are awarded during play, the game credits are typically added to a credit meter total on the EGM and can be provided to the player upon completion of a gaming session or when the player wants to “cash out.”

“Slot” type games are often displayed to the player in the form of various symbols arrayed in a row-by-column grid or matrix. Specific matching combinations of symbols along predetermined paths (or paylines) through the matrix indicate the outcome of the game. The display typically highlights winning combinations/outcomes for identification by the player. Matching combinations and their corresponding awards are usually shown in a “pay-table” which is available to the player for reference. Often, the player may vary his/her wager to include differing numbers of paylines and/or the amount bet on each line. By varying the wager, the player may sometimes alter the frequency or number of winning combinations, frequency or number of secondary games, and/or the amount awarded.

Typical games use a random number generator (RNG) to randomly determine the outcome of each game. The game is designed to return a certain percentage of the amount wagered back to the player over the course of many plays or instances of the game, which is generally referred to as return to player (RTP). The RTP and randomness of the RNG ensure the fairness of the games and are highly regulated. Upon initiation of play, the RNG randomly determines a game outcome and symbols are then selected which correspond to that outcome.

As wagering games add more complex features (e.g., so-called triple metamorphic features), it may become more difficult for the games to achieve a designated RTP. Thus, it would be beneficial for gaming devices to have the technical means to dynamically modify their operations and/or capabilities based on game features that may be triggered at a given time. Dynamically modifying operations and capabilities of an EGM would provide greater control of gameplay outcomes and maintain a designated RTP.

### SUMMARY

Certain embodiments provide a gaming device, a method of operating a gaming device, and a system where metamorphic feature types may be awarded by a game feature during a spinning reel game based on a triggering mechanism. Some games may involve what is sometimes referred to as a metamorphic feature (e.g., a game metamorphic, a metamorphic graphical element). Metamorphic features typically change or metamorphose over time in response to different gaming events. For example, in some wagering game instances, a metamorphic feature may change in response to (1) a base game outcome, (2) a random game trigger, (3) a buy/instant feature, or combinations thereof. A special symbol (e.g., a credit on reel (COR) symbol represented by a coin) may be a certain color (e.g., green, yellow, pink) and have a value on it (e.g., 10, 20, 30) that animates up to a respectively colored metamorphic element (e.g., a piggy bank) after a spin. Metamorphic elements may get bigger over time to emphasize more coins going into it during gameplay (e.g., a piggy bank is the metamorphic element that increases in size as coins animate into the piggy bank). In some embodiments, different dynamically weighted tables and/or reel strips may be utilized depending on how the game triggers the game feature. For example, the game may trigger the game feature based on a base game outcome (e.g., three, four, or five scatter credit symbols), a random feature trigger, and/or the buying of an instant feature. Based on the triggering mechanism, the spinning reel game may have different probabilities in triggering one or more of the metamorphic feature types for a single spin.

### BRIEF DESCRIPTION OF THE DRAWINGS

FIG. 1 is an exemplary diagram showing several EGMs networked with various gaming related servers.

FIG. 2A is a block diagram showing various functional elements of an exemplary EGM.

FIG. 2B depicts a casino gaming environment according to one example.

FIG. 2C is a diagram that shows examples of components of a system for providing online gaming according to some aspects of the present disclosure.

FIG. 3 illustrates, in block diagram form, an implementation of a game processing architecture algorithm that implements a game processing pipeline for the play of a game in accordance with various implementations described herein.

FIGS. 4A and 4B depict exemplary reel strips constructed for a game feature in accordance with various embodiments of the disclosure.

FIG. 5 depicts an exemplary user interface for an EGM showing a gateway feature, in accordance with various embodiments of the disclosure.

FIGS. 6A-6E depict exemplary user interfaces for an EGM showing gameplay, in accordance with various embodiments of the disclosure.

FIGS. 7A-7E depict exemplary user interfaces for an EGM showing gameplay of a free game feature, in accordance with various embodiments of the disclosure.

FIGS. 8A-8B depict an exemplary flowchart illustrating a process for playing a game, in accordance with various embodiments of the disclosure.

### DETAILED DESCRIPTION

The disclosed technology is directed to various embodiments of techniques for achieving a designated game Return to Player (RTP) for a gaming device, such as an electronic gaming machine (EGM). In some embodiments, operation of the EGM achieves a designated RTP by providing a game feature that randomly awards one or more metamorphic feature types within a single spin. Additionally, the game feature that randomly awards one or more metamorphic feature types may be based on a triggering mechanism. The disclosed technology may utilize different weight tables, reel strips, or a combination thereof depending on how the game triggers the game feature. For example, the game may trigger the game feature based on a base game outcome (e.g., e.g., three, four, or five scatter credit symbols), a random feature trigger, the buying of an instant feature, or a combination thereof. Based on the triggering mechanism used, the game may have different probabilities in triggering one or more of the metamorphic feature types for a single spin.

In some embodiments of the disclosed technology, a gaming device, or EGM, is better able to control the random awarding of one or more metamorphic feature types within a single spin while complying with regulations, such as RTP, for a game feature. In prior implementations that include a conventional base game that triggers a metamorphic game feature, the gaming device may randomly determine whether to trigger a metamorphic by performing an RNG pull for one or more designated credit symbols. Each RNG pull will randomly determine whether the game will trigger the metamorphic feature. In some instances, where the game includes multiple metamorphic elements, the gaming device may utilize a weight table that defines the probably of triggering different metamorphic features based on the type of credit symbols generated in the base game outcome. For both examples, triggering of the metamorphic features may not occur for a given spin and instead may take several spins to randomly trigger the metamorphic feature. Therefore, further control processes are needed in a random gaming environment to guarantee at least one of the metamorphic features triggers within a single game, without violating regulatory requirements.

In some embodiments, the disclosed technology is technically rooted in electronic gaming technology that generates a game outcome that triggers at least one metamorphic feature within a single spin using a two layers of control approach. For example, when the game outcome includes three credit symbols that correspond to three different game feature mechanics, a single weighting table is used that controls which ones, if any, of the three different game feature mechanics are awarded. In prior game implementations, a game controller checks each game feature independently. For example, when the game outcome includes three credit symbols that correspond to three different feature mechanics, the game controller determines whether a game feature mechanic should be awarded individually (e.g., check for first credit symbol, check for second credit symbol, check for third credit symbol). Therefore, if each game feature mechanic had a 10% chance of landing, there would be a 1 in 1,000 chance of landing all three together. In contrast, the disclosed technology provides control over the probability of awarding all three game feature mechanics together by, when all three credit symbols that correspond to three different game feature mechanics appear in the game outcome, using a second weighting table that controls which, if any, of the three feature game mechanics are awarded. This feature provides an interesting and volatile scenario because any combination of the three game feature mechanics (e.g., up to and including all three together) may be triggered with as great or as low of odds as desired.

One technical problem that may be overcome via the various embodiments and solutions described herein involves achieving a given game RTP and managing outcomes when a gameplay instance includes a triple metamorphic game feature. The embodiments described herein provide greater control over the triggering of feature game mechanics using a multi-layered approach that leverages the use of dynamically weighted tables.

### Electronic Gaming Machine (EGM) Environment

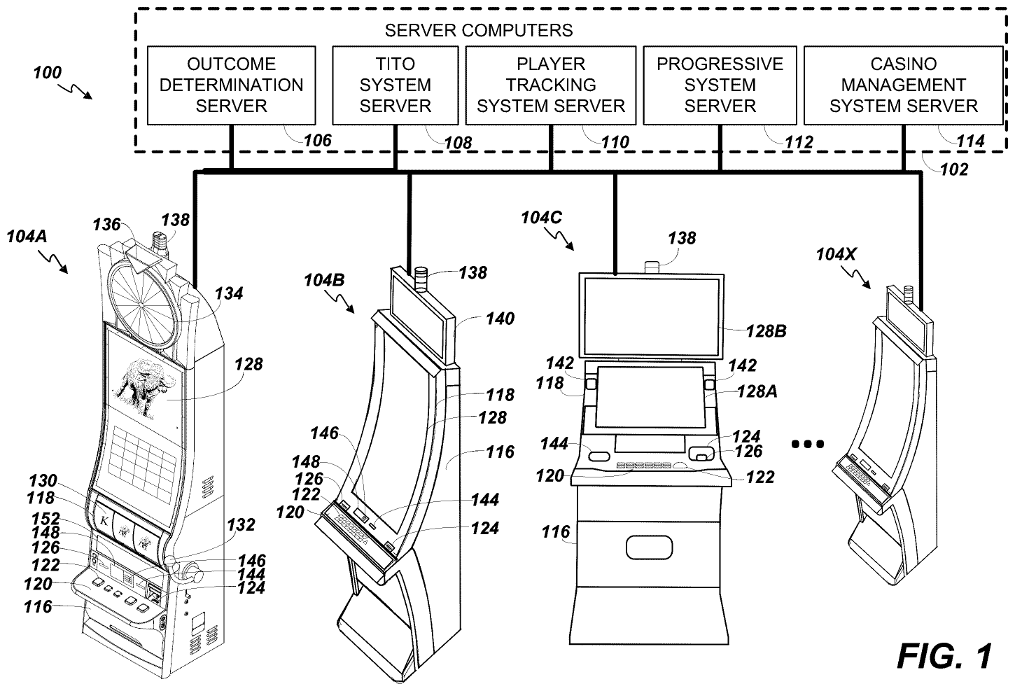

FIG. 1 illustrates several different models of EGMs which may be networked to various gaming related servers. Shown is a system 100 in a gaming environment including one or more server computers 102 (e.g., slot servers of a casino) that are in communication, via a communications network, with one or more gaming devices 104A-104X (EGMs, slots, video poker, bingo machines, etc.) that can implement one or more aspects of the present disclosure. The gaming devices 104A-104X may alternatively be portable and/or remote gaming devices such as, but not limited to, a smart phone, a tablet, a laptop, or a game console. Gaming devices 104A-104X utilize specialized software and/or hardware to form non-generic, particular machines or apparatuses that comply with regulatory requirements regarding devices used for wagering or games of chance that provide monetary awards.

Communication between the gaming devices 104A-104X and the server computers 102, and among the gaming devices 104A-104X, may be direct or indirect using one or more communication protocols. As an example, gaming devices 104A-104X and the server computers 102 can communicate over one or more communication networks, such as over the Internet through a website maintained by a computer on a remote server or over an online data network including commercial online service providers, Internet service providers, private networks (e.g., local area networks and enterprise networks), and the like (e.g., wide area networks). The communication networks could allow gaming devices 104A-104X to communicate with one another and/or the server computers 102 using a variety of communication-based technologies, such as radio frequency (RF) (e.g., wireless fidelity (Wi-Fi®) and Bluetooth®), cable TV, satellite links and the like.

In some implementation, server computers 102 may not be necessary and/or preferred. For example, in one or more implementations, a stand-alone gaming device such as gaming device 104A, gaming device 104B or any of the other gaming devices 104C-104X can implement one or more aspects of the present disclosure. However, it is typical to find multiple EGMs connected to networks implemented with one or more of the different server computers 102 described herein.

The server computers 102 may include a central determination gaming system server 106, a ticket-in-ticket-out (TITO) system server 108, a player tracking system server 110, a progressive system server 112, and/or a casino management system server 114. Gaming devices 104A-104X may include features to enable operation of any or all servers for use by the player and/or operator (e.g., the casino, resort, gaming establishment, tavern, pub, etc.). For example, game outcomes may be generated on a central determination gaming system server 106 and then transmitted over the network to any of a group of remote terminals or remote gaming devices 104A-104X that utilize the game outcomes and display the results to the players.

Gaming device 104A is often of a cabinet construction which may be aligned in rows or banks of similar devices for placement and operation on a casino floor. The gaming device 104A often includes a main door which provides access to the interior of the cabinet. Gaming device 104A typically includes a button area or button deck 120 accessible by a player that is configured with input switches or buttons 122, an access channel for a bill validator 124, and/or an access channel for a ticket-out printer 126.

In FIG. 1, gaming device 104A is shown as a Relm XL™ model gaming device manufactured by Aristocrat® Technologies, Inc. As shown, gaming device 104A is a reel machine having a gaming display area 118 comprising a number (typically 3 or 5) of mechanical reels 130 with various symbols displayed on them. The mechanical reels 130 are independently spun and stopped to show a set of symbols within the gaming display area 118 which may be used to determine an outcome to the game.

In many configurations, the gaming device 104A may have a main display 128 (e.g., video display monitor) mounted to, or above, the gaming display area 118. The main display 128 can be a high-resolution liquid crystal display (LCD), plasma, light emitting diode (LED), or organic light emitting diode (OLED) panel which may be flat or curved as shown, a cathode ray tube, or other conventional electronically controlled video monitor.

In some implementations, the bill validator 124 may also function as a “ticket-in” reader that allows the player to use a casino-issued credit ticket to load credits onto the gaming device 104A (e.g., in a cashless ticket (“TITO”) system). In such cashless implementations, the gaming device 104A may also include a “ticket-out” printer 126 for outputting a credit ticket when a “cash out” button is pressed. Cashless TITO systems are used to generate and track unique barcodes or other indicators printed on tickets to allow players to avoid the use of bills and coins by loading credits using a ticket reader and cashing out credits using a ticket-out printer 126 on the gaming device 104A. The gaming device 104A can have hardware meters for purposes including ensuring regulatory compliance and monitoring the player credit balance. In addition, there can be additional meters that record the total amount of money wagered on the gaming device, total amount of money deposited, total amount of money withdrawn, total amount of winnings on gaming device 104A.

In some implementations, a player tracking card reader 144, a transceiver for wireless communication with a mobile device (e.g., a player's smartphone), a keypad 146, and/or an illuminated display 148 for reading, receiving, entering, and/or displaying player tracking information is provided in gaming device 104A. In such implementations, a game controller within the gaming device 104A can communicate with the player tracking system server 110 to send and receive player tracking information.

Gaming device 104A may also include a bonus topper wheel 134. When bonus play is triggered (e.g., by a player achieving a particular outcome or set of outcomes in the primary game), bonus topper wheel 134 is operative to spin and stop with indicator arrow 136 indicating the outcome of the bonus game. Bonus topper wheel 134 is typically used to play a bonus game, but it could also be incorporated into play of the base or primary game.

A candle 138 may be mounted on the top of gaming device 104A and may be activated by a player (e.g., using a switch or one of buttons 122) to indicate to operations staff that gaming device 104A has experienced a malfunction or the player requires service. The candle 138 is also often used to indicate a jackpot has been won and to alert staff that a hand payout of an award may be needed.

There may also be one or more information panels 152 which may be a back-lit, silkscreened glass panel with lettering to indicate general game information including, for example, a game denomination (e.g., $0.25 or $1), pay lines, pay tables, and/or various game related graphics. In some implementations, the information panel(s) 152 may be implemented as an additional video display.

Gaming devices 104A have traditionally also included a handle 132 typically mounted to the side of main cabinet 116 which may be used to initiate game play.

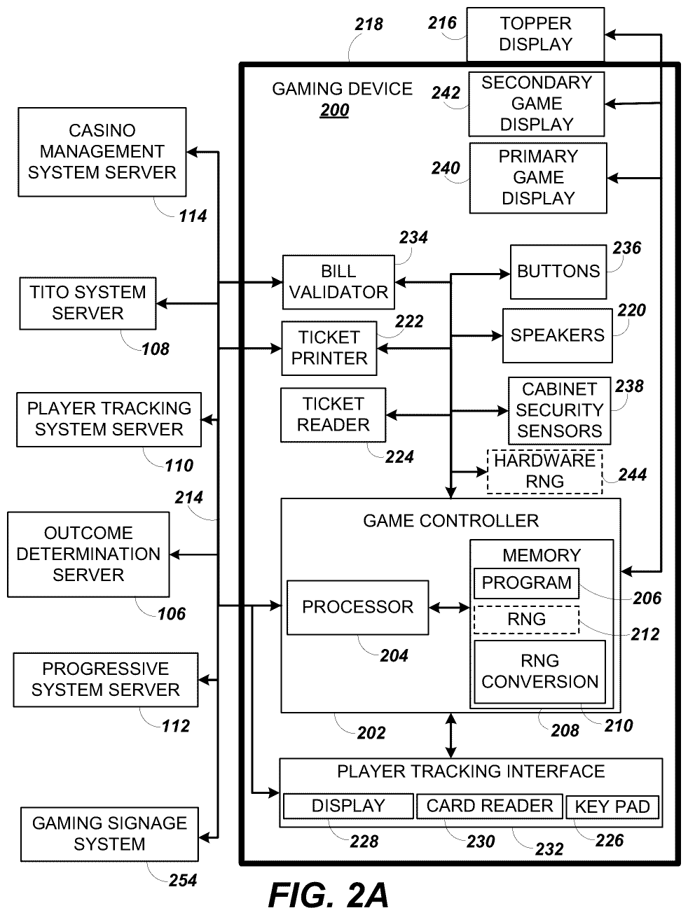

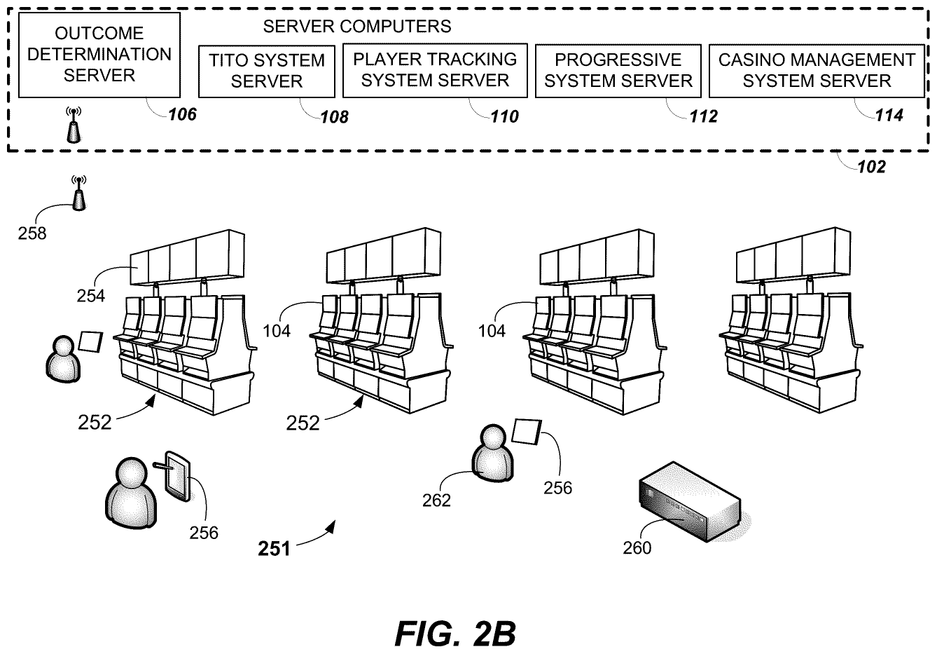

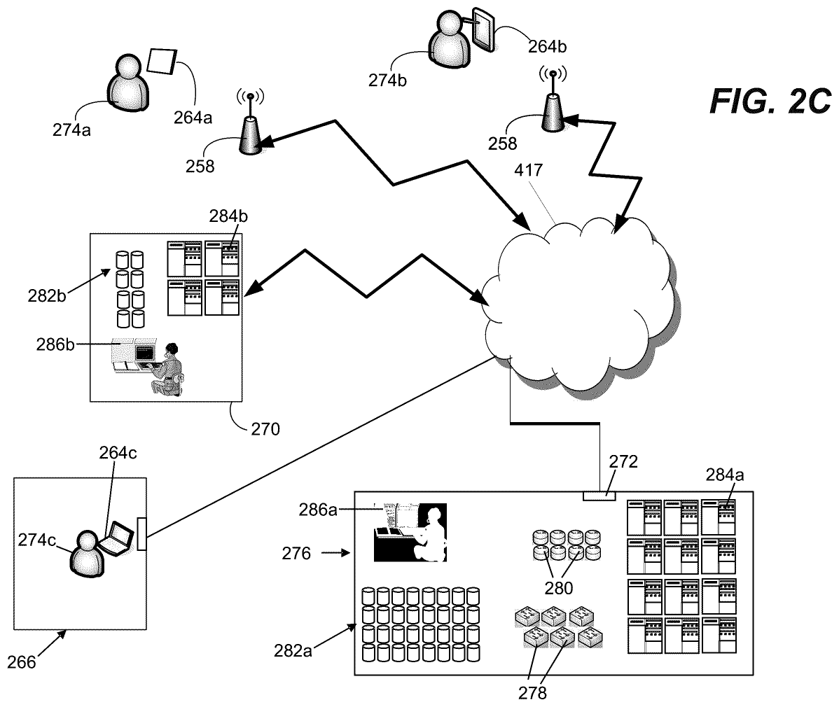

Many or all the above described components can be controlled by circuitry (e.g., a game controller) housed inside the main cabinet 116 of the gaming device 104A, the details of which are shown in FIG. 2A.

An alternative example gaming device 104B illustrated in FIG. 1 is the Arc™ model gaming device manufactured by Aristocrat® Technologies, Inc. Note that where possible, reference numerals identifying similar features of the gaming device 104A implementation are also identified in the gaming device 104B implementation using the same reference numbers. Gaming device 104B does not include physical reels and instead shows game play functions on main display 128. An optional topper screen 140 may be used as a secondary game display for bonus play, to show game features or attraction activities while a game is not in play, or any other information or media desired by the game designer or operator. In some implementations, the optional topper screen 140 may also or alternatively be used to display progressive jackpot prizes available to a player during play of gaming device 104B.

Example gaming device 104B includes a main cabinet 116 including a main door which opens to provide access to the interior of the gaming device 104B. The main or service door is typically used by service personnel to refill the ticket-out printer 126 and collect bills and tickets inserted into the bill validator 124. The main or service door may also be accessed to reset the machine, verify and/or upgrade the software, and for general maintenance operations.

Another example gaming device 104C shown is the Helix™ model gaming device manufactured by Aristocrat® Technologies, Inc. Gaming device 104C includes a main display 128A that is in a landscape orientation. Although not illustrated by the front view provided, the main display 128A may have a curvature radius from top to bottom, or alternatively from side to side. In some implementations, main display 128A is a flat panel display. Main display 128A is typically used for primary game play while secondary display 128B is typically used for bonus game play, to show game features or attraction activities while the game is not in play or any other information or media desired by the game designer or operator. In some implementations, example gaming device 104C may also include speakers 142 to output various audio such as game sound, background music, etc.

Many different types of games, including mechanical slot games, video slot games, video poker, video blackjack, video pachinko, keno, bingo, and lottery, may be provided with or implemented within the depicted gaming devices 104A-104C and other similar gaming devices. Each gaming device may also be operable to provide many different games. Games may be differentiated according to themes, sounds, graphics, type of game (e.g., slot game vs. card game vs. game with aspects of skill), denomination, number of paylines, maximum jackpot, progressive or non-progressive, bonus games, and may be deployed for operation in Class 2 or Class 3, etc.

FIG. 2A is a block diagram depicting exemplary internal electronic components of a gaming device 200 connected to various external systems. All or parts of the gaming device 200 shown could be used to implement any one of the example gaming devices 104A-X depicted in FIG. 1. As shown in FIG. 2A, gaming device 200 includes a topper display 216 or another form of a top box (e.g., a topper wheel, a topper screen, etc.) that sits above cabinet 218. Cabinet 218 or topper display 216 may also house a number of other components which may be used to add features to a game being played on gaming device 200, including speakers 220, a ticket printer 222 which prints barcoded tickets or other media or mechanisms for storing or indicating a player's credit value, a ticket reader 224 which reads barcoded tickets or other media or mechanisms for storing or indicating a player's credit value, and a player tracking interface 232. Player tracking interface 232 may include a keypad 226 for entering information, a player tracking display 228 for displaying information (e.g., an illuminated or video display), a card reader 230 for receiving data and/or communicating information to and from media or a device such as a smart phone enabling player tracking. FIG. 2 also depicts utilizing a ticket printer 222 to print tickets for a TITO system server 108. Gaming device 200 may further include a bill validator 234, player-input buttons 236 for player input, cabinet security sensors 238 to detect unauthorized opening of the cabinet 218, a primary game display 240, and a secondary game display 242, each coupled to and operable under the control of game controller 202.

The games available for play on the gaming device 200 are controlled by a game controller 202 that includes one or more processors 204. Processor 204 represents a general-purpose processor, a specialized processor intended to perform certain functional tasks, or a combination thereof. As an example, processor 204 can be a central processing unit (CPU) that has one or more multi-core processing units and memory mediums (e.g., cache memory) that function as buffers and/or temporary storage for data. Alternatively, processor 204 can be a specialized processor, such as an application specific integrated circuit (ASIC), graphics processing unit (GPU), field-programmable gate array (FPGA), digital signal processor (DSP), or another type of hardware accelerator. In another example, processor 204 is a system on chip (SoC) that combines and integrates one or more general-purpose processors and/or one or more specialized processors. Although FIG. 2A illustrates that game controller 202 includes a single processor 204, game controller 202 is not limited to this representation and instead can include multiple processors 204 (e.g., two or more processors).

FIG. 2A illustrates that processor 204 is operatively coupled to memory 208. Memory 208 is defined herein as including volatile and nonvolatile memory and other types of non-transitory data storage components. Volatile memory is memory that do not retain data values upon loss of power. Nonvolatile memory is memory that do retain data upon a loss of power. Examples of memory 208 include random access memory (RAM), read-only memory (ROM), hard disk drives, solid-state drives, universal serial bus (USB) flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, examples of RAM include static random access memory (SRAM), dynamic random access memory (DRAM), magnetic random access memory (MRAM), and other such devices. Examples of ROM include a programmable read-only memory (PROM), an erasable programmable read-only memory (EPROM), an electrically erasable programmable read-only memory (EEPROM), or other like memory device. Even though FIG. 2A illustrates that game controller 202 includes a single memory 208, game controller 202 could include multiple memories 208 for storing program instructions and/or data.

Memory 208 can store one or more game programs 206 that provide program instructions and/or data for carrying out various implementations (e.g., game mechanics) described herein. Stated another way, game program 206 represents an executable program stored in any portion or component of memory 208. In one or more implementations, game program 206 is embodied in the form of source code that includes human-readable statements written in a programming language or machine code that contains numerical instructions recognizable by a suitable execution system, such as a processor 204 in a game controller or other system. Examples of executable programs include: (1) a compiled program that can be translated into machine code in a format that can be loaded into a random access portion of memory 208 and run by processor 204; (2) source code that may be expressed in proper format such as object code that is capable of being loaded into a random access portion of memory 208 and executed by processor 204; and (3) source code that may be interpreted by another executable program to generate instructions in a random access portion of memory 208 to be executed by processor 204.

Alternatively, game programs 206 can be set up to generate one or more game instances based on instructions and/or data that gaming device 200 exchanges with one or more remote gaming devices, such as a central determination gaming system server 106 (not shown in FIG. 2A but shown in FIG. 1). For purpose of this disclosure, the term “game instance” refers to a play or a round of a game that gaming device 200 presents (e.g., via a user interface (UI)) to a player. The game instance is communicated to gaming device 200 via the network 214 and then displayed on gaming device 200. For example, gaming device 200 may execute game program 206 as video streaming software that allows the game to be displayed on gaming device 200. When a game is stored on gaming device 200, it may be loaded from memory 208 (e.g., from a read only memory (ROM)) or from the central determination gaming system server 106 to memory 208.

Gaming devices, such as gaming device 200, are highly regulated to ensure fairness and, in many cases, gaming device 200 is operable to award monetary awards (e.g., typically dispensed in the form of a redeemable voucher). Therefore, to satisfy security and regulatory requirements in a gaming environment, hardware and software architectures are implemented in gaming devices 200 that differ significantly from those of general-purpose computers. Adapting general purpose computers to function as gaming devices 200 is not simple or straightforward because of: (1) the regulatory requirements for gaming devices 200, (2) the harsh environment in which gaming devices 200 operate, (3) security requirements, (4) fault tolerance requirements, and (5) the requirement for additional special purpose componentry enabling functionality of an EGM. These differences require substantial engineering effort with respect to game design implementation, game mechanics, hardware components, and software.

One regulatory requirement for games running on gaming device 200 generally involves complying with a certain level of randomness. Typically, gaming jurisdictions mandate that gaming devices 200 satisfy a minimum level of randomness without specifying how a gaming device 200 should achieve this level of randomness. To comply, FIG. 2A illustrates that gaming device 200 could include an RNG 212 that utilizes hardware and/or software to generate RNG outcomes that lack any pattern. The RNG operations are often specialized and non-generic in order to comply with regulatory and gaming requirements. For example, in a slot game, game program 206 can initiate multiple RNG calls to RNG 212 to generate RNG outcomes, where each RNG call and RNG outcome corresponds to an outcome for a reel. In another example, gaming device 200 can be a Class II gaming device where RNG 212 generates RNG outcomes for creating Bingo cards. In one or more implementations, RNG 212 could be one of a set of RNGs operating on gaming device 200. More generally, an output of the RNG 212 can be the basis on which game outcomes are determined by the game controller 202. Game developers could vary the degree of true randomness for each RNG (e.g., pseudorandom) and utilize specific RNGs depending on game requirements. The output of the RNG 212 can include a random number or pseudorandom number (either is generally referred to as a “random number”).

In FIG. 2A, RNG 212 and hardware RNG 244 are shown in dashed lines to illustrate that RNG 212, hardware RNG 244, or both can be included in gaming device 200. In one implementation, instead of including RNG 212, gaming device 200 could include a hardware RNG 244 that generates RNG outcomes. Analogous to RNG 212, hardware RNG 244 performs specialized and non-generic operations in order to comply with regulatory and gaming requirements. For example, because of regulation requirements, hardware RNG 244 could be a random number generator that securely produces random numbers for cryptography use. The gaming device 200 then uses the secure random numbers to generate game outcomes for one or more game features. In another implementation, the gaming device 200 could include both hardware RNG 244 and RNG 212. RNG 212 may utilize the RNG outcomes from hardware RNG 244 as one of many sources of entropy for generating secure random numbers for the game features.

Another regulatory requirement for running games on gaming device 200 includes ensuring a certain level of RTP. Similar to the randomness requirement discussed above, numerous gaming jurisdictions also mandate that gaming device 200 provides a minimum level of RTP (e.g., RTP of at least 75%). A game can use one or more lookup tables (also called weighted tables) as part of a technical solution that satisfies regulatory requirements for randomness and RTP. In particular, a lookup table can integrate game features (e.g., trigger events for special modes or bonus games; newly introduced game elements such as extra reels, new symbols, or new cards; stop positions for dynamic game elements such as spinning reels, spinning wheels, or shifting reels; or card selections from a deck) with random numbers generated by one or more RNGs, so as to achieve a given level of volatility for a target level of RTP. (In general, volatility refers to the frequency or probability of an event such as a special mode, payout, etc. For example, for a target level of RTP, a higher-volatility game may have a lower payout most of the time with an occasional bonus having a very high payout, while a lower-volatility game has a steadier payout with more frequent bonuses of smaller amounts.) Configuring a lookup table can involve engineering decisions with respect to how RNG outcomes are mapped to game outcomes for a given game feature, while still satisfying regulatory requirements for RTP. Configuring a lookup table can also involve engineering decisions about whether different game features are combined in a given entry of the lookup table or split between different entries (for the respective game features), while still satisfying regulatory requirements for RTP and allowing for varying levels of game volatility.

FIG. 2A illustrates that gaming device 200 includes an RNG conversion engine 210 that translates the RNG outcome from RNG 212 to a game outcome presented to a player. To meet a designated RTP, a game developer can set up the RNG conversion engine 210 to utilize one or more lookup tables to translate the RNG outcome to a symbol element, stop position on a reel strip layout, and/or randomly chosen aspect of a game feature. As an example, the lookup tables can regulate a prize payout amount for each RNG outcome and how often the gaming device 200 pays out the prize payout amounts. The RNG conversion engine 210 could utilize one lookup table to map the RNG outcome to a game outcome displayed to a player and a second lookup table as a pay table for determining the prize payout amount for each game outcome. The mapping between the RNG outcome to the game outcome controls the frequency in hitting certain prize payout amounts.

FIG. 2A also depicts that gaming device 200 is connected over network 214 to player tracking system server 110. Player tracking system server 110 may be, for example, an OASIS® system manufactured by Aristocrat® Technologies, Inc. Player tracking system server 110 is used to track play (e.g., amount wagered, games played, time of play and/or other quantitative or qualitative measures) for individual players so that an operator may reward players in a loyalty program. The player may use the player tracking interface 232 to access his/her account information, activate free play, and/or request various information. Player tracking or loyalty programs seek to reward players for their play and help build brand loyalty to the gaming establishment. The rewards typically correspond to the player's level of patronage (e.g., to the player's playing frequency and/or total amount of game plays at a given casino). Player tracking rewards may be complimentary and/or discounted meals, lodging, entertainment and/or additional play. Player tracking information may be combined with other information that is now readily obtainable by a casino management system.

When a player wishes to play the gaming device 200, he/she can insert cash or a ticket voucher through a coin acceptor (not shown) or bill validator 234 to establish a credit balance on the gaming device. The credit balance is used by the player to place wagers on instances of the game and to receive credit awards based on the outcome of winning instances. The credit balance is decreased by the amount of each wager and increased upon a win. The player can add additional credits to the balance at any time. The player may also optionally insert a loyalty club card into the card reader 230. During the game, the player views with one or more UIs the game outcome on one or more of the primary game display(s) 240 and secondary game display 242. Other game and prize information may also be displayed.

For each game instance, a player may make selections, which may affect play of the game. For example, the player may vary the total amount wagered by selecting the amount bet per line and the number of lines played. In many games, the player is asked to initiate or select options during course of game play (such as spinning a wheel to begin a bonus round or select various items during a feature game). The player may make these selections using the player-input buttons 236, the primary game display 240 which may be a touch screen, or using some other device which enables a player to input information into the gaming device 200.

During certain game events, the gaming device 200 may display visual and auditory effects that can be perceived by the player. These effects add to the excitement of a game, which makes a player more likely to enjoy the playing experience. Auditory effects include various sounds that are projected by the speakers 220. Visual effects include flashing lights, strobing lights or other patterns displayed from lights on the gaming device 200 or from lights behind the information panel 152 (FIG. 1).

When the player is done, he/she cashes out the credit balance (typically by pressing a cash out button to receive a ticket from the ticket printer 222). The ticket may be “cashed-in” for money or inserted into another machine to establish a credit balance for play.

Additionally, or alternatively, gaming devices 104A-104X and 200 can include or be coupled to one or more wireless transmitters, receivers, and/or transceivers (not shown in FIGS. 1 and 2A) that communicate (e.g., Bluetooth® or other near-field communication technology) with one or more mobile devices to perform a variety of wireless operations in a casino environment. Examples of wireless operations in a casino environment include detecting the presence of mobile devices, performing credit, points, comps, or other marketing or hard currency transfers, establishing wagering sessions, and/or providing a personalized casino-based experience using a mobile application. In one implementation, to perform these wireless operations, a wireless transmitter or transceiver initiates a secure wireless connection between a gaming device 104A-104X and 200 and a mobile device. After establishing a secure wireless connection between the gaming device 104A-104X and 200 and the mobile device, the wireless transmitter or transceiver does not send and/or receive application data to and/or from the mobile device. Rather, the mobile device communicates with gaming devices 104A-104X and 200 using another wireless connection (e.g., Wi-Fi® or cellular network). In another implementation, a wireless transceiver establishes a secure connection to directly communicate with the mobile device. The mobile device and gaming device 104A-104X and 200 sends and receives data utilizing the wireless transceiver instead of utilizing an external network. For example, the mobile device would perform digital wallet transactions by directly communicating with the wireless transceiver. In one or more implementations, a wireless transmitter could broadcast data received by one or more mobile devices without establishing a pairing connection with the mobile devices.

Although FIGS. 1 and 2A illustrate specific implementations of a gaming device (e.g., gaming devices 104A-104X and 200), the disclosure is not limited to those implementations shown in FIGS. 1 and 2. For example, not all gaming devices suitable for implementing implementations of the present disclosure necessarily include top wheels, top boxes, information panels, cashless ticket systems, and/or player tracking systems. Further, some suitable gaming devices have only a single game display that includes only a mechanical set of reels and/or a video display, while others are designed for bar counters or tabletops and have displays that face upwards. Gaming devices 104A-104X and 200 may also include other processors that are not separately shown. Using FIG. 2A as an example, gaming device 200 could include display controllers (not shown in FIG. 2A) configured to receive video input signals or instructions to display images on game displays 240 and 242. Alternatively, such display controllers may be integrated into the game controller 202. The use and discussion of FIGS. 1 and 2 are examples to facilitate ease of description and explanation.

FIG. 2B depicts a casino gaming environment according to one example. In this example, the casino 251 includes banks 252 of EGMs 104. In this example, each bank 252 of EGMs 104 includes a corresponding gaming signage system 254 (also shown in FIG. 2A). According to this implementation, the casino 251 also includes mobile gaming devices 256, which are also configured to present wagering games in this example. The mobile gaming devices 256 may, for example, include tablet devices, cellular phones, smart phones and/or other handheld devices. In this example, the mobile gaming devices 256 are configured for communication with one or more other devices in the casino 251, including but not limited to one or more of the server computers 102, via wireless access points 258.

According to some examples, the mobile gaming devices 256 may be configured for stand-alone determination of game outcomes. However, in some alternative implementations the mobile gaming devices 256 may be configured to receive game outcomes from another device, such as the central determination gaming system server 106, one of the EGMs 104, etc.

Some mobile gaming devices 256 may be configured to accept monetary credits from a credit or debit card, via a wireless interface (e.g., via a wireless payment app), via tickets, via a patron casino account, etc. However, some mobile gaming devices 256 may not be configured to accept monetary credits via a credit or debit card. Some mobile gaming devices 256 may include a ticket reader and/or a ticket printer whereas some mobile gaming devices 256 may not, depending on the particular implementation.

In some implementations, the casino 251 may include one or more kiosks 260 that are configured to facilitate monetary transactions involving the mobile gaming devices 256, which may include cash out and/or cash in transactions. The kiosks 260 may be configured for wired and/or wireless communication with the mobile gaming devices 256. The kiosks 260 may be configured to accept monetary credits from casino patrons 262 and/or to dispense monetary credits to casino patrons 262 via cash, a credit or debit card, via a wireless interface (e.g., via a wireless payment app), via tickets, etc. According to some examples, the kiosks 260 may be configured to accept monetary credits from a casino patron and to provide a corresponding amount of monetary credits to a mobile gaming device 256 for wagering purposes, e.g., via a wireless link such as a near-field communications link. In some such examples, when a casino patron 262 is ready to cash out, the casino patron 262 may select a cash out option provided by a mobile gaming device 256, which may include a real button or a virtual button (e.g., a button provided via a graphical user interface) in some instances. In some such examples, the mobile gaming device 256 may send a “cash out” signal to a kiosk 260 via a wireless link in response to receiving a “cash out” indication from a casino patron. The kiosk 260 may provide monetary credits to the casino patron 262 corresponding to the “cash out” signal, which may be in the form of cash, a credit ticket, a credit transmitted to a financial account corresponding to the casino patron, etc.

In some implementations, a cash-in process and/or a cash-out process may be facilitated by the TITO system server 108. For example, the TITO system server 108 may control, or at least authorize, ticket-in and ticket-out transactions that involve a mobile gaming device 256 and/or a kiosk 260.

Some mobile gaming devices 256 may be configured for receiving and/or transmitting player loyalty information. For example, some mobile gaming devices 256 may be configured for wireless communication with the player tracking system server 110. Some mobile gaming devices 256 may be configured for receiving and/or transmitting player loyalty information via wireless communication with a patron's player loyalty card, a patron's smartphone, etc.

According to some implementations, a mobile gaming device 256 may be configured to provide safeguards that prevent the mobile gaming device 256 from being used by an unauthorized person. For example, some mobile gaming devices 256 may include one or more biometric sensors and may be configured to receive input via the biometric sensor(s) to verify the identity of an authorized patron. Some mobile gaming devices 256 may be configured to function only within a predetermined or configurable area, such as a casino gaming area.

FIG. 2C is a diagram that shows examples of components of a system for providing online gaming according to some aspects of the present disclosure. As with other figures presented in this disclosure, the numbers, types and arrangements of gaming devices shown in FIG. 2C are merely shown by way of example. In this example, various gaming devices, including but not limited to end user devices (EUDs) 264a, 264b and 264c are capable of communication via one or more networks 417. The networks 417 may, for example, include one or more cellular telephone networks, the Internet, etc. In this example, the EUDs 264a and 264b are mobile devices: according to this example the EUD 264a is a tablet device and the EUD 264b is a smart phone. In this implementation, the EUD 264c is a laptop computer that is located within a residence 266 at the time depicted in FIG. 2C. Accordingly, in this example the hardware of EUDs is not specifically configured for online gaming, although each EUD is configured with software for online gaming. For example, each EUD may be configured with a web browser. Other implementations may include other types of EUD, some of which may be specifically configured for online gaming.

In this example, a gaming data center 276 includes various devices that are configured to provide online wagering games via the networks 417. The gaming data center 276 is capable of communication with the networks 417 via the gateway 272. In this example, switches 278 and routers 280 are configured to provide network connectivity for devices of the gaming data center 276, including storage devices 282a, servers 284a and one or more workstations 570a. The servers 284a may, for example, be configured to provide access to a library of games for online game play. In some examples, code for executing at least some of the games may initially be stored on one or more of the storage devices 282a. The code may be subsequently loaded onto a server 284a after selection by a player via an EUD and communication of that selection from the EUD via the networks 417. The server 284a onto which code for the selected game has been loaded may provide the game according to selections made by a player and indicated via the player's EUD. In other examples, code for executing at least some of the games may initially be stored on one or more of the servers 284a. Although only one gaming data center 276 is shown in FIG. 2C, some implementations may include multiple gaming data centers 276.

In this example, a financial institution data center 270 is also configured for communication via the networks 417. Here, the financial institution data center 270 includes servers 284b, storage devices 282b, and one or more workstations 286b. According to this example, the financial institution data center 270 is configured to maintain financial accounts, such as checking accounts, savings accounts, loan accounts, etc. In some implementations one or more of the authorized users 274a-274c may maintain at least one financial account with the financial institution that is serviced via the financial institution data center 270.

According to some implementations, the gaming data center 276 may be configured to provide online wagering games in which money may be won or lost. According to some such implementations, one or more of the servers 284a may be configured to monitor player credit balances, which may be expressed in game credits, in currency units, or in any other appropriate manner. In some implementations, the server(s) 284a may be configured to obtain financial credits from and/or provide financial credits to one or more financial institutions, according to a player's “cash in” selections, wagering game results and a player's “cash out” instructions. According to some such implementations, the server(s) 284a may be configured to electronically credit or debit the account of a player that is maintained by a financial institution, e.g., an account that is maintained via the financial institution data center 270. The server(s) 284a may, in some examples, be configured to maintain an audit record of such transactions.

In some alternative implementations, the gaming data center 276 may be configured to provide online wagering games for which credits may not be exchanged for cash or the equivalent. In some such examples, players may purchase game credits for online game play, but may not “cash out” for monetary credit after a gaming session. Moreover, although the financial institution data center 270 and the gaming data center 276 include their own servers and storage devices in this example, in some examples the financial institution data center 270 and/or the gaming data center 276 may use offsite “cloud-based” servers and/or storage devices. In some alternative examples, the financial institution data center 270 and/or the gaming data center 276 may rely entirely on cloud-based servers.

One or more types of devices in the gaming data center 276 (or elsewhere) may be capable of executing middleware, e.g., for data management and/or device communication. Authentication information, player tracking information, etc., including but not limited to information obtained by EUDs 264 and/or other information regarding authorized users of EUDs 264 (including but not limited to the authorized users 274a-274c), may be stored on storage devices 282 and/or servers 284. Other game-related information and/or software, such as information and/or software relating to leaderboards, players currently playing a game, game themes, game-related promotions, game competitions, etc., also may be stored on storage devices 282 and/or servers 284. In some implementations, some such game-related software may be available as “apps” and may be downloadable (e.g., from the gaming data center 276) by authorized users.

In some examples, authorized users and/or entities (such as representatives of gaming regulatory authorities) may obtain gaming-related information via the gaming data center 276. One or more other devices (such EUDs 264 or devices of the gaming data center 276) may act as intermediaries for such data feeds. Such devices may, for example, be capable of applying data filtering algorithms, executing data summary and/or analysis software, etc. In some implementations, data filtering, summary and/or analysis software may be available as “apps” and downloadable by authorized users.

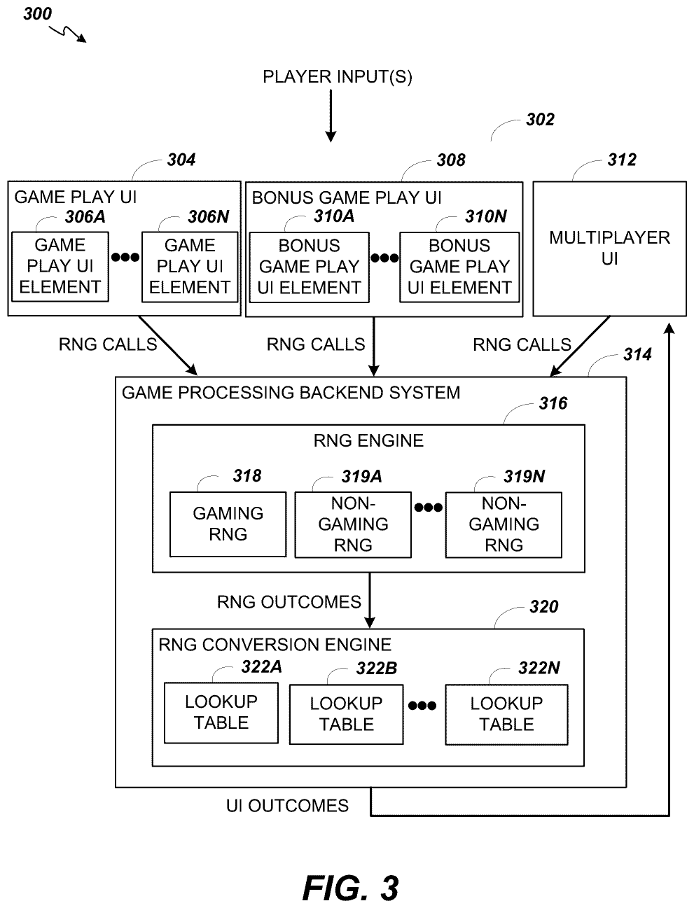

FIG. 3 illustrates, in block diagram form, an implementation of a game processing architecture 300 that implements a game processing pipeline for the play of a game in accordance with various implementations described herein. As shown in FIG. 3, the gaming processing pipeline starts with having a UI system 302 receive one or more player inputs for the game instance. Based on the player input(s), the UI system 302 generates and sends one or more RNG calls to a game processing backend system 314. Game processing backend system 314 then processes the RNG calls with RNG engine 316 to generate one or more RNG outcomes. The RNG outcomes are then sent to the RNG conversion engine 320 to generate one or more game outcomes for the UI system 302 to display to a player. The game processing architecture 300 can implement the game processing pipeline using a gaming device, such as gaming devices 104A-104X and 200 shown in FIGS. 1 and 2, respectively. Alternatively, portions of the gaming processing architecture 300 can implement the game processing pipeline using a gaming device and one or more remote gaming devices, such as central determination gaming system server 106 shown in FIG. 1.

The UI system 302 includes one or more UIs that a player can interact with. The UI system 302 could include one or more game play UIs 304, one or more bonus game play UIs 308, and one or more multiplayer UIs 312, where each UI type includes one or more mechanical UIs and/or graphical UIs (GUIs). In other words, game play UI 304, bonus game play UI 308, and the multiplayer UI 312 may utilize a variety of UI elements, such as mechanical UI elements (e.g., physical “spin” button or mechanical reels) and/or GUI elements (e.g., virtual reels shown on a video display or a virtual button deck) to receive player inputs and/or present game play to a player. Using FIG. 3 as an example, the different UI elements are shown as game play UI elements 306A-306N and bonus game play UI elements 310A-310N.

The game play UI 304 represents a UI that a player typically interfaces with for a base game. During a game instance of a base game, the game play UI elements 306A-306N (e.g., GUI elements depicting one or more virtual reels) are shown and/or made available to a user. In a subsequent game instance, the UI system 302 could transition out of the base game to one or more bonus games. The bonus game play UI 308 represents a UI that utilizes bonus game play UI elements 310A-310N for a player to interact with and/or view during a bonus game. In one or more implementations, at least some of the game play UI element 306A-306N are similar to the bonus game play UI elements 310A-310N. In other implementations, the game play UI element 306A-306N can differ from the bonus game play UI elements 310A-310N.

FIG. 3 also illustrates that UI system 302 could include a multiplayer UI 312 purposed for game play that differs or is separate from the typical base game. For example, multiplayer UI 312 could be set up to receive player inputs and/or presents game play information relating to a tournament mode. When a gaming device transitions from a primary game mode that presents the base game to a tournament mode, a single gaming device is linked and synchronized to other gaming devices to generate a tournament outcome. For example, multiple RNG engines 316 corresponding to each gaming device could be collectively linked to determine a tournament outcome. To enhance a player's gaming experience, tournament mode can modify and synchronize sound, music, reel spin speed, and/or other operations of the gaming devices according to the tournament game play. After tournament game play ends, operators can switch back the gaming device from tournament mode to a primary game mode to present the base game. Although FIG. 3 does not explicitly depict that multiplayer UI 312 includes UI elements, multiplayer UI 312 could also include one or more multiplayer UI elements.

Based on the player inputs, the UI system 302 could generate RNG calls to a game processing backend system 314. As an example, the UI system 302 could use one or more application programming interfaces (APIs) to generate the RNG calls. To process the RNG calls, the RNG engine 316 could utilize gaming RNG 318 and/or non-gaming RNGs 319A-319N. Gaming RNG 318 could corresponds to RNG 212 or hardware RNG 244 shown in FIG. 2A. As previously discussed with reference to FIG. 2A, gaming RNG 318 often performs specialized and non-generic operations that comply with regulatory and/or game requirements. For example, because of regulation requirements, gaming RNG 318 could correspond to RNG 212 by being a cryptographic RNG or pseudorandom number generator (PRNG) (e.g., Fortuna PRNG) that securely produces random numbers for one or more game features. To securely generate random numbers, gaming RNG 318 could collect random data from various sources of entropy, such as from an operating system (OS) and/or a hardware RNG (e.g., hardware RNG 244 shown in FIG. 2A). Alternatively, non-gaming RNGs 319A-319N may not be cryptographically secure and/or be computationally less expensive. Non-gaming RNGs 319A-319N can, thus, be used to generate outcomes for non-gaming purposes. As an example, non-gaming RNGs 319A-319N can generate random numbers for generating random messages that appear on the gaming device.

The RNG conversion engine 320 processes each RNG outcome from RNG engine 316 and converts the RNG outcome to a UI outcome that is feedback to the UI system 302. With reference to FIG. 2A, RNG conversion engine 320 corresponds to RNG conversion engine 210 used for game play. As previously described, RNG conversion engine 320 translates the RNG outcome from the RNG 212 to a game outcome presented to a player. RNG conversion engine 320 utilizes one or more lookup tables 322A-322N to regulate a prize payout amount for each RNG outcome and how often the gaming device pays out the derived prize payout amounts. In one example, the RNG conversion engine 320 could utilize one lookup table to map the RNG outcome to a game outcome displayed to a player and a second lookup table as a pay table for determining the prize payout amount for each game outcome. In this example, the mapping between the RNG outcome and the game outcome controls the frequency in hitting certain prize payout amounts. Different lookup tables could be utilized depending on the different game modes, for example, a base game versus a bonus game.

After generating the UI outcome, the game processing backend system 314 sends the UI outcome to the UI system 302. Examples of UI outcomes are symbols to display on a video reel or reel stops for a mechanical reel. In one example, if the UI outcome is for a base game, the UI system 302 updates one or more game play UI elements 306A-306N, such as symbols, for the game play UI 304. In another example, if the UI outcome is for a bonus game, the UI system could update one or more bonus game play UI elements 310A-310N (e.g., symbols) for the bonus game play UI 308. In response to updating the appropriate UI, the player may subsequently provide additional player inputs to initiate a subsequent game instance that progresses through the game processing pipeline.

### Implementation of Base Game and Feature Games

Achieving a designated game RTP for an improved gaming device operation/capability that provides a game feature (i.e., bank buster spin) that randomly awards one or more metamorphic feature types within a single spin and based on a triggering mechanism. Specifically, the improved gaming device operation/capability utilizes different weight tables and/or reel strips depending on how the game triggers the game feature. As an example, the game can trigger the game feature (i.e., bank buster spin) based on a base game outcome (3 SCAT, 4 SCAT, and/or 5 SCAT), a random feature trigger, and/or buying an instant feature. Based on the triggering mechanism, the game will have different probabilities in triggering one or more of the metamorphic feature types for a single spin.

The disclosed technology is technically rooted in gaming technology using a game mechanic that generates a game outcome that triggers at least one metamorphic feature within a single spin. To generate a single spin game outcome that guarantees activating one or more metamorphic game features and to comply with gaming regulations, process controls are implemented for a single spin include, but not limited to, a triggering mechanism, reel strip construction, the generation of color and prize symbols for credit symbols, color credit symbol combinations that affect the triggering of a metamorphic feature, and color credit symbol combinations that affect reel strips used in a free game feature. Additionally, the game mechanic may generate a game outcome that triggers at least one metamorphic feature within a single spin using a two layers of control approach. For example, when the game outcome includes three credit symbols that correspond to three different game feature mechanics, a single weighting table may be used that controls which ones, if any, of the three different game feature mechanics are awarded. Control is provided over the probability of awarding all three game feature mechanics together by, when all three credit symbols that correspond to three different game feature mechanics appear in the game outcome, using a second weighting table that controls which, if any, of the three feature game mechanics are awarded. The combination of the three game feature mechanics (e.g., up to and including all three together) may be triggered using a single reference being made to a weighting table.

In some embodiments, a triggering mechanism that activates a game feature is provided. A game feature may be activated by one or more methods including, but not limited to, a base game outcome, a random game trigger, or a buy/instant feature. With respect to a base game outcome, the base game may include multiple reel sets (e.g., reel set A and B). In one example implementation, one reel set may be constructed to favor generating higher paying combinations while another reel set may be constructed to favor generating more scatter, or credit, symbols that trigger the game feature. Additionally, or alternatively, a random game trigger may include performing an additional RNG pull to determine whether to trigger the game feature regardless of the base game outcome. In another embodiment, a player may be given the opportunity to make a wager to buy the game feature.

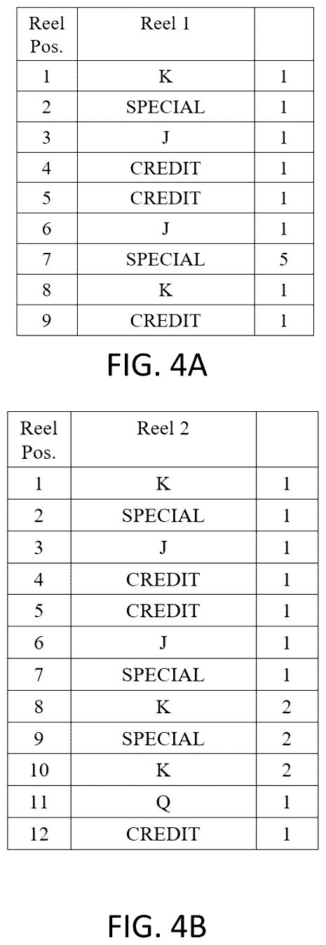

In some embodiments, reel strips may be constructed for a game feature. For example, reel strips may be constructed such that each reel is guaranteed to land at least one credit symbol (e.g., also referred to herein as a Cash on Reel, or “COR,” symbol). Referring to FIG. 4A, Reel 1 may be created to include nine-reel positions, and the space between the credit symbols may be three symbol positions or less. Such reel construction may give a player more opportunities to land credit symbols that correspond to different metamorphic features. At time of reel selection (e.g., time of spin), the color or prize of the credit symbol is assigned, or populated, using one or more RNGs. For example, a set of reels is selected from a plurality of reel sets to choose from. Additionally, the type of reels, or set of reels, may be controlled to populate the credit symbols with certain color or prize symbols (e.g., green, gold) by the game mechanic using one or more dynamic weight tables. For example, green may be weighted more heavily than gold. An RNG may be used to select a color that corresponds to a certain game feature mechanic as well as a credit prize value (e.g., jackpot feature, ‘200’). In another example, if the game feature is triggered with a ‘buy’ a feature, the game feature may use a different reel strip that may not generate at least one credit symbol on all reels, only some of the reels. Referring to FIG. 4B, Reel 2 may be constructed to include 12 reels positions. Reel 2 may include more space between the credit symbols, such as five symbol positions or less. Reel 1 and Reel 2 of FIGS. 4A and 4B are merely examples of what symbols reel strips may include and are not meant to be limiting.

In some embodiments, a color and a prize value may be generated for each of the credit symbols. For example, a color generated and assigned to a credit symbol (e.g., a green coin) is associated with one of the metamorphic features (e.g., a green pig). Additionally, a credit symbol may also be assigned a prize value. To assign color type and prize value, the game mechanic may create multiple reel sets that are weighted to more likely generate a certain color credit symbol, prize value, or a combination thereof. For example, the game mechanic may generate a number of reel sets, e.g., eight reel sets labeled as reel sets A-H, by assigning likelihoods of triggering the metamorphic features and prize value. In some embodiments, reel set A may be more likely to generate color credit symbols associated with metamorphic feature A with relatively higher credit values. In contrast, reel set B may be more likely to generate color credit symbols associated with metamorphic feature B with relatively higher credit values. In another example, reel set H may be configured to generate color credit symbols to be substantially similar for all colors with relatively lower credit values. Color and prize values may be generated with each spin during gameplay.

In some embodiments, different color credit symbol combinations may affect the triggering of one or more metamorphic features. For example, the game mechanic may randomly determine what metamorphic feature to trigger given the color types that land within the single spin. Because the game feature requires at least one of the metamorphic features to trigger, the game mechanic may utilize a weight table that is constructed to trigger at least one of the metamorphic features. The combination of color types determines the likelihood of triggering different features. For example, within a single spin, based on which color types are shown determines which weighted table may be used to control the likelihood of which game features are triggered based on a result from an RNG. For example, when three color types are shown (e.g., green, yellow, red), each of which are associated with a different game feature, a weighted table may be used to determine whether any (e.g., some, none, or all) of three game features are actually triggered. A differently-weighted table may be used when only two color types are shown (e.g., green, yellow) after a single spin. In this example, when three color types are shown, the weighted table used may assign the green game feature mechanic a 25% chance of being triggered, and when two color types are shown, the weighted table used may assign the green game feature a 33% chance of being triggered.

In some embodiments, metamorphic elements may be metamorphic images that change in response to game event data during gameplay of an EGM. For example, different graphical representations of metamorphic elements may correspond to game outcomes or results, triggering mechanism outcomes, game status or progress, prizes awarded, or the like. Additionally, changes to graphical representations of metamorphic elements may be used to visually indicate to a player occurrence of game events that enhance gameplay. In some implementations, representations of metamorphic elements may correspond to the accumulation of awarded prizes or as credit symbols appear within game outcomes. For example, a metamorphic element may increase in size visually each time a credit symbol appears within a game outcome (e.g., a reel spin). Additionally, metamorphic elements may differentiate from one another by being associated with different game features, colors, visual styles, size, or the like.

In some embodiments, metamorphic elements may each be associated with a free game feature mechanic. Game feature mechanics that may be activated during a bonus gameplay round in which “free games” have been awarded to a player include: an expand feature, a repeat feature, or a jackpot feature. More specifically, the expand feature causes one prize to be duplicated or copied (e.g., one prize is expanded to four prizes) onto additional reel positions, the jackpot feature provides a free game feature mechanic that provides additional opportunities to win jackpot prizes, and the repeat feature provides a free game opportunity to repeat prior actions, such as reel spins, etc. During gameplay, a game feature of a metamorphic element may be triggered based on game event data, a game outcome, or in response to an RNG outcome. Additionally, during gameplay, as described herein, when multiple metamorphic elements are provided, any number of the metamorphic elements' feature games may be triggered, or none at all. For example, based on game event data, when three metamorphic elements are provided, where each element is associated with at least one free game feature, just one may be triggered, two may be triggered, or even all three may be triggered. The free game features may be played in combination, as described further below.

In some embodiments, color credit symbol combinations may affect reel strips used in a free game feature. For example, the free games feature could utilize one of the different reel strip sets, for example, reel strip sets A, B, and C. The different reel strips may be weighted differently to affect the probability of landing credit symbols. The credit symbol combinations that landed in the game feature spin may affect the likelihood of utilizing the different reel strip sets.

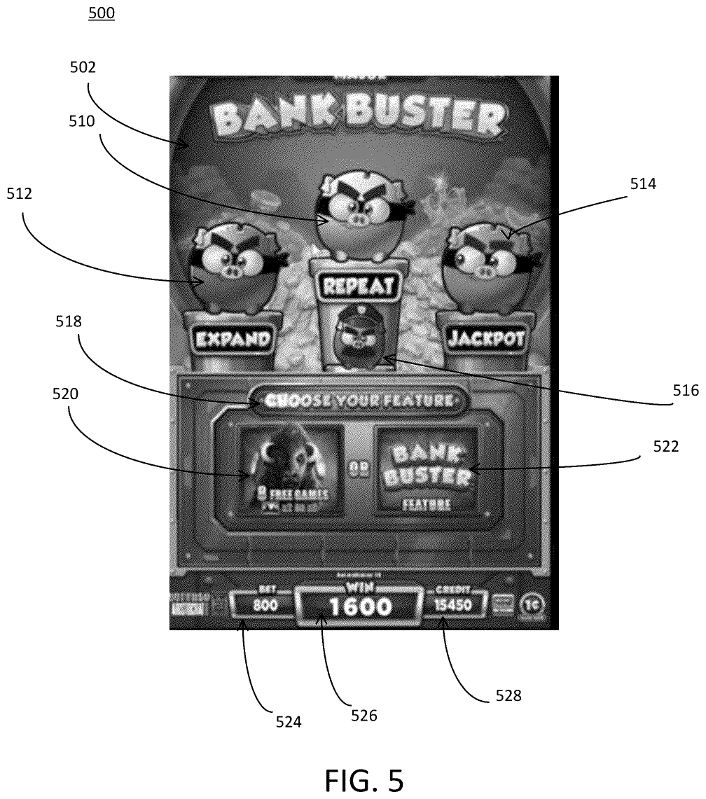

Referring to FIG. 5, a display screen 500 is illustrated showing a gateway feature in one example of the disclosed embodiments. As depicted in FIG. 5, display screen 500 shows a view of an exemplary user interface for an EGM showing a base game window 502 in accordance with various embodiments of the disclosure. In this example, window 502 includes four metamorphic graphical elements, 510, 512, 514, and 516. A gateway feature 518 is shown where a player may select from option 520 or option 522. By selecting option 520, the player is given the opportunity to play a bonus gameplay round. During play of the bonus game, the game mechanic may trigger the game feature based on an RNG pull. In this example, when the game feature is triggered, a metamorphic element may indicate this visually to a player. For example, metamorphic element 516 may change in style, shape, color, or the like to visually indicate to a player that a game feature has been activated. By selecting option 522, the player is given the opportunity to play the bonus game with the feature game mechanics. Additionally, when selecting option 522, the player may be expected to place a wager to play with the feature game. Additional elements may be shown in window 502 including a bet amount portion 524, a win amount portion 526, and a credit amount portion 528. Based on how the game feature was triggered may determine which weight tables are used for the game feature (e.g., 3, 4, or 5 scatter symbols, random feature, instant feature).

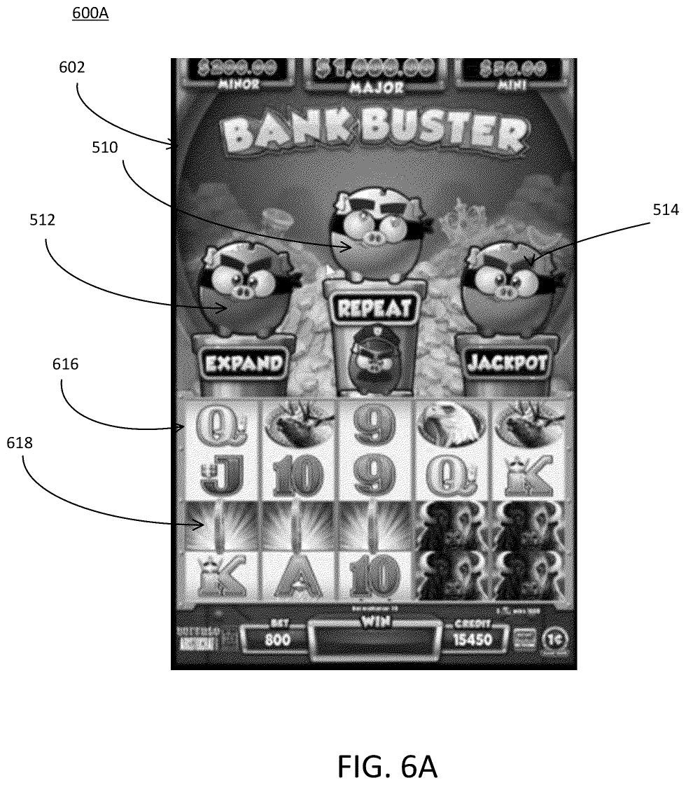

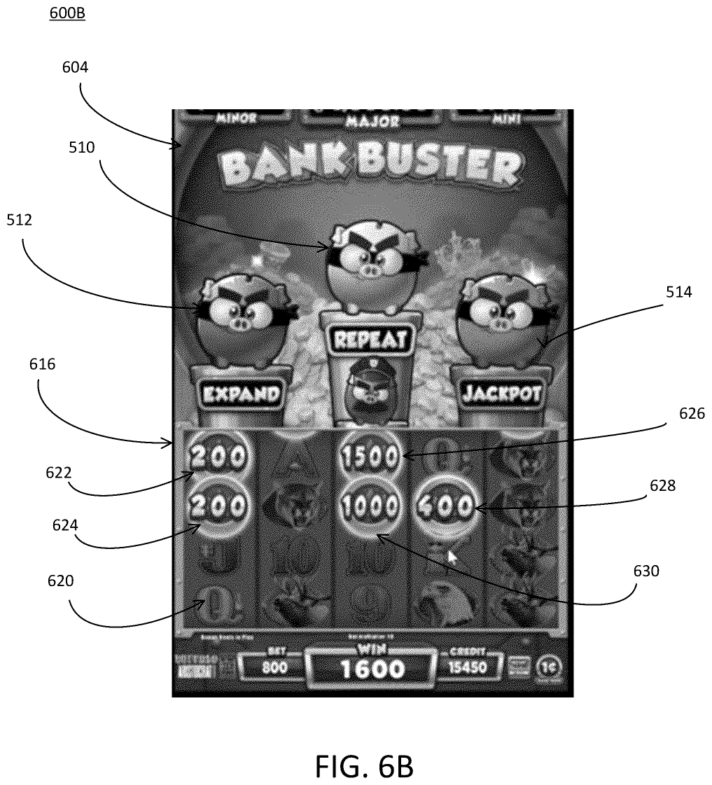

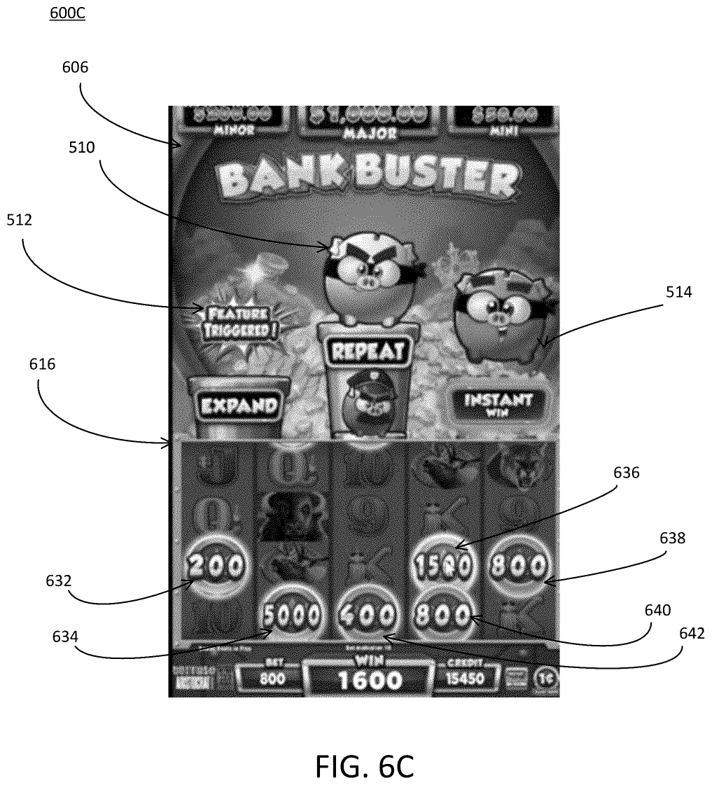

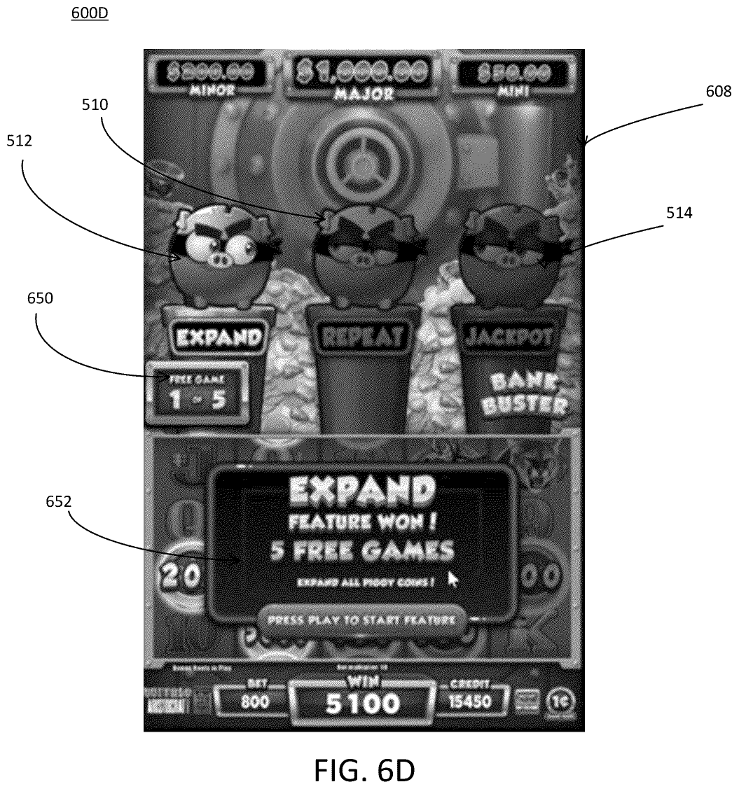

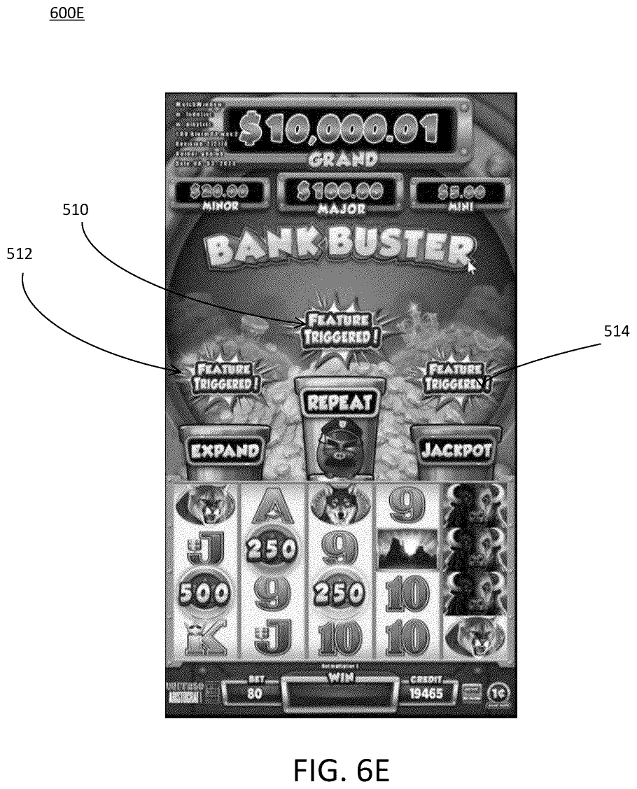

Referring to FIG. 6A, a display screen 600A is illustrated showing a base game outcome that triggers a game feature in one example of the disclosed embodiments. As depicted in FIG. 6A, display screen 600A shows a view of an exemplary user interface for an EGM showing a base game window 602 in accordance with various embodiments of the disclosure. In this example, window 602 includes four metamorphic graphical elements, 510, 512, 514 and 516, and a plurality of reels 616. In this example, a base game outcome may trigger a game feature by including a predetermined number of symbols, such as a predetermined number of scatter symbols. As shown in base game outcome of reels 616, the outcome includes three scatter symbols 618. In other implementations, the predetermined number of symbols may be four scatter symbols, five scatter symbols, or other types of symbol combinations. In some embodiments, when a game outcome includes a certain number of special symbols, additional prizes or awards may be credited to the player. Display screen 600A would then transition to display 600B of FIG. 6B.

As depicted in FIG. 6B, display screen 600B shows a feature game window 604 in accordance with various embodiments of the disclosure. In this example, bonus reels may be displayed, and a free spin may be awarded. After the bonus reels are spun, an outcome may be shown as illustrated by reel display portion 616. During this phase of the game, symbols that do not pay out, or do not affect the outcome of the free spin, may be greyed out, such as symbol 620. Other symbols, for example color credit symbols 622, 624, 626, 628, and 630, may be illuminated. Each color credit symbol is associated with one of the metamorphic elements 510, 512, 514. Association between a color credit symbol and a metamorphic element may be indicated based on each being of the same color. For example, color credit symbols 622 and 628 are green and therefore be associated with green metamorphic element 512. In another example, color credit symbols 624, 626, and 630 are pink and therefore be associated with pink metamorphic element 514. After spinning the bonus reels, the metamorphic elements 510, 512, and 514 may become animated. For example, each credit symbol may be visually displayed, or animated, as being sent to their respective metamorphic element (e.g., send pink credit symbol 624 to pink metamorphic element 514). In some embodiments, color credit symbols may appear anywhere on the reels and randomly trigger feature games. At the end of the free spin, the game mechanic may use an RNG pull to determine whether an instant win feature has been triggered. Additionally, as the animations are shown (e.g., send coins to corresponding piggy banks), the game mechanic may use an RNG pull to determine whether one or more free game features associated with the metamorphic elements should be triggered. In this example, a weighted table may be used to determine whether a feature game mechanic associated with the pink metamorphic element 514, the Jackpot feature game, should be triggered. The determination may be done using an RNG with a weighted table that is used when no other color credit symbols are present.

Referring to FIG. 6C, display screen 600C shows a view of an exemplary user interface for an EGM showing a feature game window 606 in accordance with various embodiments of the disclosure. In this example, window 606 shows another outcome of spinning the bonus reels. For example, in display portion 616, color credit symbols 632, 634, 636, 638, 640, and 642 are displayed. As the animations are shown for the color credit symbols (e.g., coins being sent to their corresponding piggy banks), a determination is made whether any of the feature games should be triggered. In this example, color credit symbols associated with all three metamorphic elements 510, 512 and 514 are part of the game outcome. Therefore, the game mechanic selects a weighted table for when three different colors are part of the game outcome. Using an RNG pull and the weighted table, it is determined which combination of features should be triggered (e.g., none, expand/repeat, repeat/jackpot, expand/repeat/jackpot, etc.). As shown, metamorphic element 512 has changed to indicate that the feature (e.g., expand feature) has been triggered.

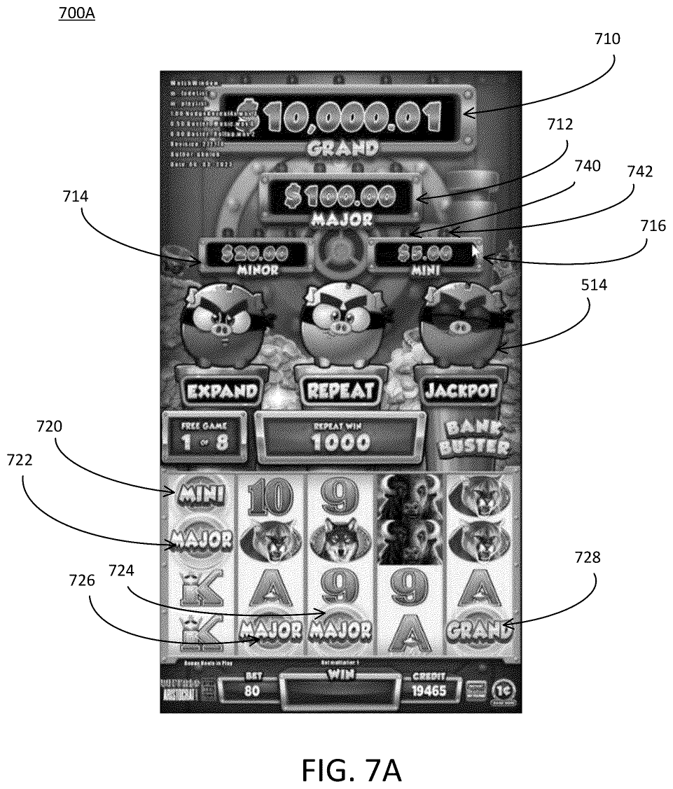

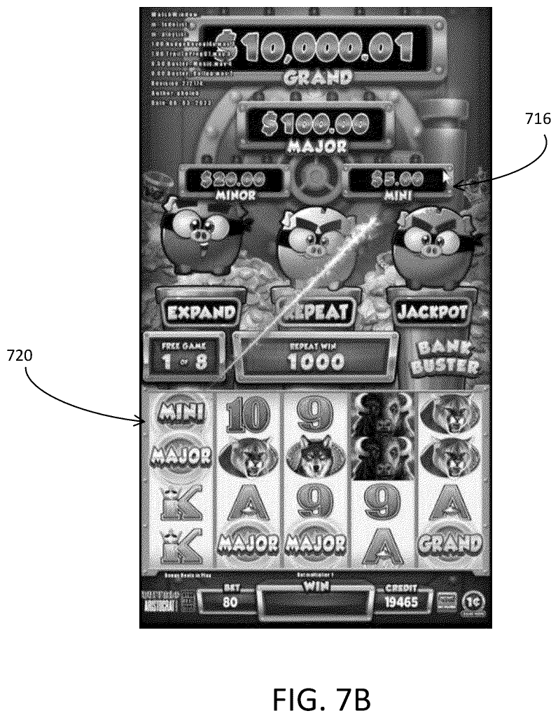

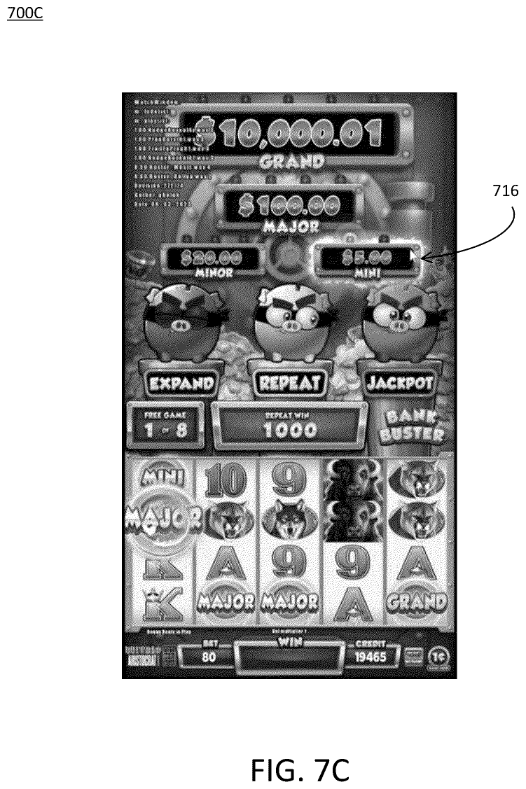

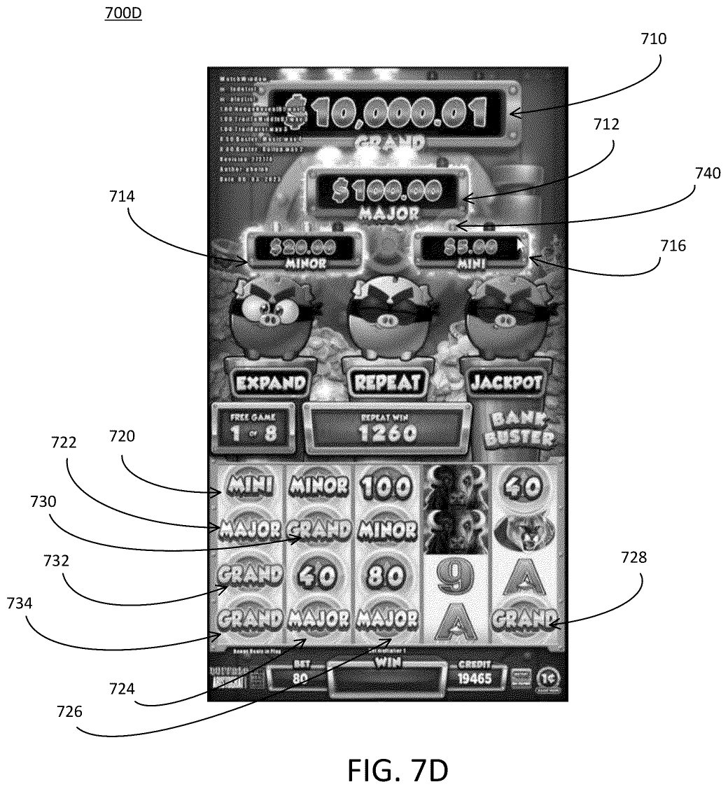

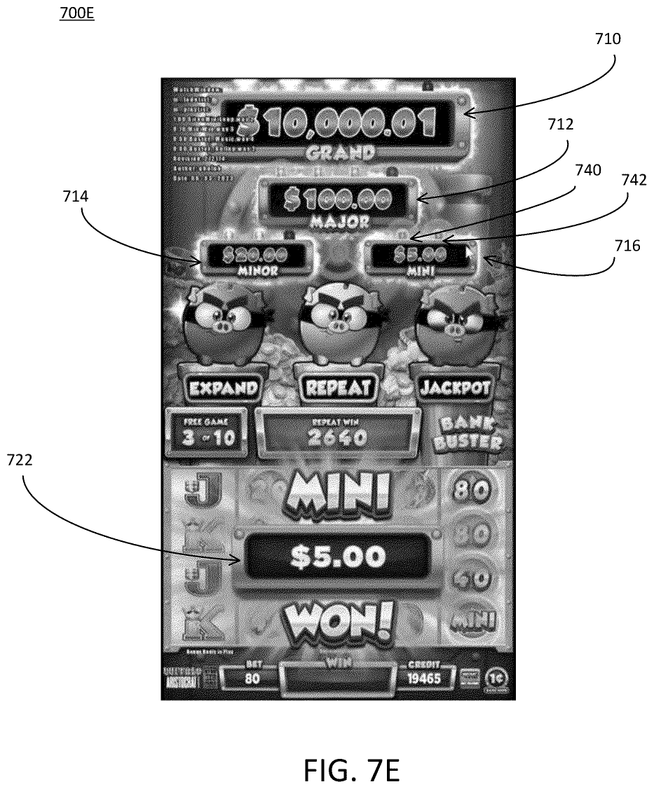

Referring to FIG. 6D, display screen 600D shows a feature game window 608 when the expand game feature has been triggered during gameplay. In this example, a free game feature (e.g., EXPAND) associated with metamorphic element 512 has been triggered. As shown, element 512 may continue to be animated and accompanied by an additional window 650. Other metamorphic elements 510 and 514 may continue to be animated, however they are greyed out because the free game features associated with 510 and 514 have not been triggered. Further details of the expand feature are displayed in window 652. During gameplay of the expand feature, color credit symbols may be copied onto additional reel positions that are visible on a given reel at the conclusion of a spin, thereby replacing the original reel values with the expanded symbol. The expand feature, in some embodiments, provides opportunities to win additional game features, such as game features associated with metamorphic element 510 (e.g., repeat feature) or 514 (e.g., jackpot feature). Each of the features may have their own game mechanic within the game feature, as described herein. In another example, referring to FIG. 6E, all three free game features may be triggered based on an RNG pull, causing metamorphic elements 510, 512, and 514 to change visually. For example, when the expand feature is activated and a prize award is shown, the prize award may be animated to become four prize awards and the player will receive all four. When the jackpot feature is activated, the player will be given opportunities to win jackpot prizes, as described in FIG. 7. When the repeat feature is activated, after the feature game is completed, everything that was awarded may be awarded multiple times. For example, an award may be repeated between 3-8 times. The number of times an award is repeated may be determined using an RNG.

As depicted in FIG. 7A, display screen 700A shows a free game feature window in accordance with various embodiments of the disclosure. In this example, the free game feature triggered is a jackpot feature associated with metamorphic element 514. The jackpot feature may use additional portions of the display to show different types of jackpot amounts. For example, Grand 710, Major 712, Minor 714, and Mini 716. Each jackpot portion may include visual indicators (e.g., siren lights), such as light indicators 740 and 742, to visually indicate to a player how close they are to winning the respective jackpot amount. For example, a reel spin during the jackpot feature may reveal jackpot credit symbols appropriately labeled with which jackpot portion they should be credited to. For example, Mini credit 720, Major credits 722, 724 and 726, and Grand credit 728. Each jackpot credit may be credited to their respective jackpot portion. See, for example, in FIGS. 7B and 7C, Mini credit 720 is animatedly credited to portion 716, causing a visual indicator 730 to illuminate. As shown in FIG. 7D, additional jackpot credit symbols have been credited, causing additional visual indicators (e.g., flashing lights) of 710, 712 and 714 to become active. FIG. 7D also demonstrates the expand game mechanic, where additional Grand credit symbols 730, 732 and 734 have been awarded because of Grand credit symbol 728. As shown in FIG. 7E, after additional jackpot feature game spins, all visual indicators of jackpot portion 716 have been activated (indicators 740 and 742), causing the jackpot being awarded, as indicated by portion 722 of the user interface. Additional jackpot portions may be awarded, based on different game outcomes.

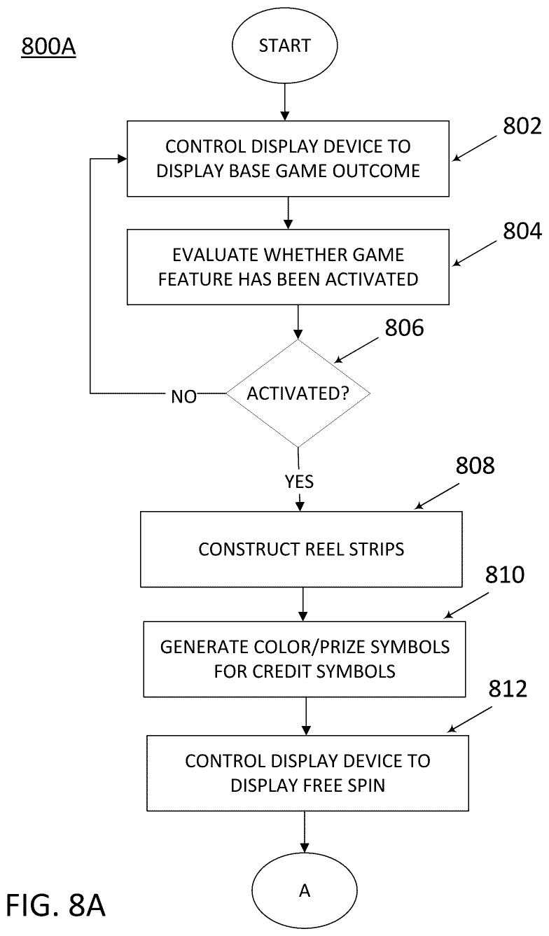

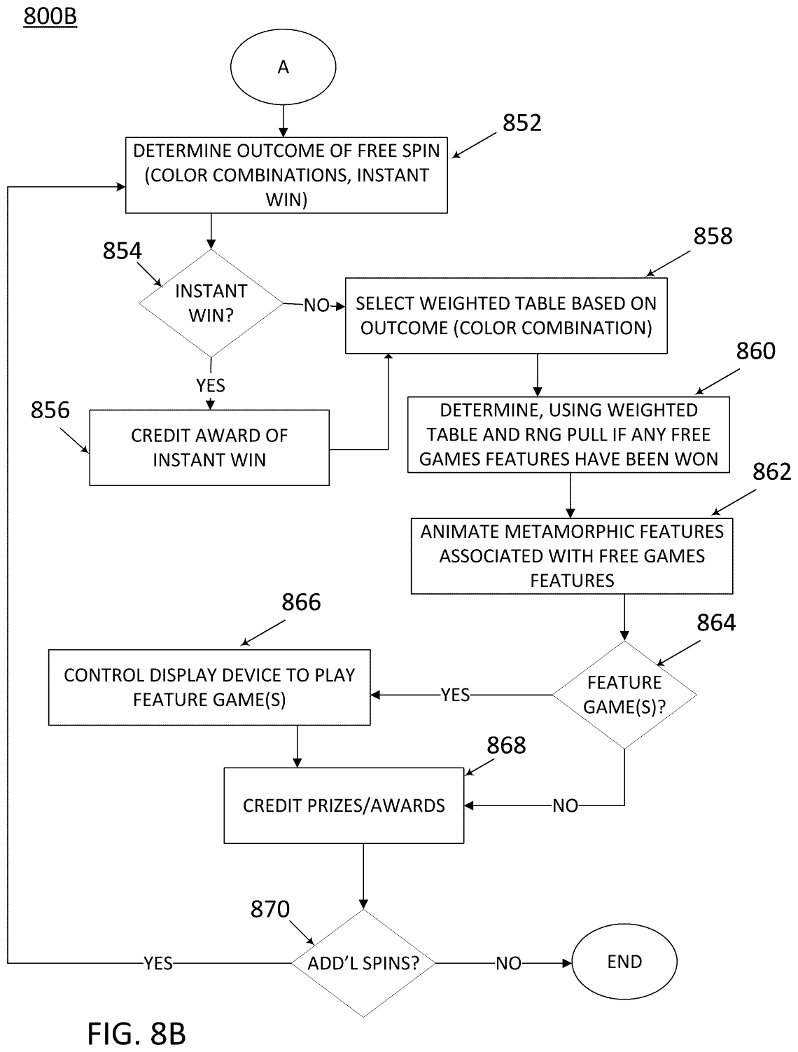

FIGS. 8A-8B depict a flowchart 800 illustrating a set of operations of a process to play a base game and additional feature games, according to various examples. The process may be implemented using gaming device 200 and the components illustrated in FIG. 3, in accordance with various examples. For example, a game controller (202) of a gaming device (e.g., gaming device 200) may execute instructions on one or more processors of the gaming device to cause the gaming device 200 to perform the operations of FIG. 8. In block 802, a display system may be controlled to display a base game. The base game may be provided and an outcome of a first instance of the base game may be determined. For example, a call may be issued to an RNG to determine the base game outcome. Further details of determining outcomes are discussed above in FIGS. 2, 4A and 4B. For example, a call to an RNG may be issued to determine the symbols that are displayed within a matrix of the base game, such as standard symbols, special symbols, wildcard symbols, credit symbols, prize symbols, or the like.

In block 804, the base game outcome is evaluated to determine whether a game feature has been activated. A game feature, as described herein, may be triggered, or activated, by a base game outcome, a random game trigger, or a buy/instant feature. In block 806, if the game feature has not been activated (‘NO’), then the base game is displayed and resumed (Block 802). In block 806, if the game feature has been activated (‘YES’), then reel strips are selected in block 808. Reel strips may be selected from a set of pre-constructed reel strips. Reel strips may be selected to give a player more opportunities to land credit symbols that correspond to different metamorphic features which correspond to different feature games. Based on how the game feature was triggered in block 804 may affect how the reel strips are selected. For example, a reel strip selected for a game feature triggered through the buy/instant feature could be set up to generate a higher RTP when compared to a reel strip selected for a game feature triggered through a base game outcome. The constructed reel strips may include COR symbols (i.e., “Cash on Reel” symbols) in some symbol positions, as described above with respect to FIGS. 4A and 4B.

At block 810, color and prize/credit value (or other characteristics or sets of characteristics, as desired for a given implementation) may be generated for the respective COR symbols. Once generated, each of the color and prize symbols may be populated to the COR symbols of the selected reel strips. Each of the colors may correspond to a color-coded metamorphic element of the game feature. As described herein, the color and prize symbols may be assigned to reel sets that are weighted to more likely generate a certain color credit symbol and/or prize value. Once the reel strips have been selected and fully populated with color and prize/credit value characteristics, in block 812 the display system may be controlled to display an outcome of the reel strips after a spin. In some embodiments, the spin may be a bonus reel spin (e.g., a free game spin). The bonus reel spin may be provided, and an outcome of an instance of the bonus reel spin may be determined in block 852. For example, a call may be issued to an RNG to determine the bonus reel spin outcome. Further details of determining outcomes are discussed above in FIGS. 2, 4A and 4B. For example, a call to an RNG may be issued to determine the symbols that are displayed within a matrix of the bonus reel spin, such as standard symbols, special symbols, wildcard symbols, COR symbols (which can be converted into the aforementioned color credit symbols), or the like. In some embodiments, all symbols displayed may be grayed out, except for the color credit symbols. In block 854, it is determined whether an instant win should be awarded. If an instant win should be awarded (‘YES’), then in block 856 the award, or result, of the instant win is credited to the player's account and flow proceeds to block 858. If the instant win should not be awarded (‘NO’), then the flow proceeds to block 858.

In block 858 of FIG. 8B, a weighted table is randomly selected from among a plurality of weighted tables. In particular, the selected weighted table may comprise assigned outcome probabilities for each possible combination of colors and credit prize values for such colors. In some embodiments, there may be, e.g., three possible colors (e.g., pink, green, yellow) that may be part of the outcome, each of which colors may have eight different credit prize values (e.g., 40, 80, 100, 150, 500, 1,000, 2,500, and 5,000), which would result in 24 different potential color/credit prize value combinations. Each of the colors may also be associated with one feature game (e.g., pink-jackpot feature, yellow-repeat feature, green-expand feature) and a metamorphic element.

Another weighted table may be selected with assigned outcome probabilities based on the combination of color credit symbols (e.g., green only, green and pink, pink only, all three colors, etc.) that have landed on a given bonus spin. In some embodiments, the assigned outcome probabilities in the another weighted table may include probabilities that a given combination of landed color credit symbols results in: a) nothing happening for one or more of the color credit symbols that have been landed on the given spin; b) an instant win event happening for one or more of the color credit symbols that have been landed on the given spin; or c.) a feature trigger event happening for one or more (up to all) of the color credit symbols that have been landed on the given spin.

In block 860, it is determined, using the selected weighted table, if any of the free game features (e.g., jackpot, repeat, expand) have been instantly won or triggered. For example, a call to an RNG may be issued to determine if instances of any of the free game features should be provided by referencing the corresponding another weighted table using the random number. In one example, if the bonus reel spin outcome included green and pink color credit symbols, the another weighted table corresponding to a presence of green and pink color credit symbols (and, by extension, an absence of yellow color credit symbols) would be selected (referred to herein as the “green and pink” weighted table). The green and pink weighted table would provide the following possibilities: no free feature games awarded, only the green feature game (e.g., expand feature) awarded, only the pink feature game (e.g., jackpot feature) awarded, or both the green and pink feature games being awarded. In block 862, while the weighted table is being selected in block 858 and whether any feature games have been won is being determined in block 860, metamorphic features provided by the display system may become animated, as described herein. At block 864, if no free feature games have been awarded (‘NO’), prizes and/or credits indicated by color credit symbols within the game outcome may be awarded (e.g., colored coin values are credited to the player's account) in block 868. At block 870, if the player has additional bonus spins available (‘YES’), the process repeats again at block 852. At block 870, if the player has no additional bonus spins available (‘NO’), the process ends. At block 864, if free feature games have been awarded (‘YES’), then at block 866 the display device is controlled to provide the free feature games to the player. The free feature games may be stacked. For example, the free feature games may be played simultaneously (e.g., expand feature and jackpot feature may be provided during free feature game spins). At the conclusion of each feature game (e.g., after each spin), prizes and/or credits indicated by color credit symbols within the feature game outcome may be awarded (e.g., colored coin values are credited to the player's account) in block 868. At block 870, if the player has additional bonus spins available (‘YES’), the process repeats again at block 852. At block 870, if the player has no additional bonus spins available (‘NO’), the process ends.

### Other Considerations

Numerous embodiments are described in this disclosure and are presented for illustrative purposes only. The described embodiments are not, and are not intended to be, limiting in any sense. The present disclosure is widely applicable to numerous embodiments, as is readily apparent from the disclosure. One of ordinary skill in the art will recognize that the innovations described herein may be practiced with various modifications and alterations, such as structural, logical, software, and electrical modifications. Although particular features of the innovations described herein may be described with reference to one or more particular embodiments and/or drawings, it should be understood that such features are not limited to usage in the one or more particular embodiments or drawings with reference to which they are described, unless expressly specified otherwise.

The present disclosure is neither a literal description of all embodiments nor a listing of features of the innovations described herein that must be present in all embodiments.

The Title (set forth at the beginning of the first page of this disclosure) is not to be taken as limiting in any way as the scope of the disclosed embodiments.

When an ordinal number (such as “first,” “second,” “third” and so on) is used as an adjective before a term, that ordinal number is used (unless expressly specified otherwise) merely to indicate a particular feature, such as to distinguish that particular feature from another feature that is described by the same term or by a similar term. For example, a “first widget” may be so named merely to distinguish it from, e.g., a “second widget.” Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget“ ” (1) does not indicate that either widget comes before or after any other in order or location; (2) does not indicate that either widget occurs or acts before or after any other in time; and (3) does not indicate that either widget ranks above or below any other, as in importance or quality. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

When introducing elements of aspects of the present disclosure or embodiments thereof, the articles “a,” “an,” “the,” and “said” are intended to mean that there are one or more of the elements. The terms “comprising,” including,” and “having” are intended to be inclusive and mean that there may be additional elements other than the listed elements.

When a single device, component, structure, or article is described herein, more than one device, component, structure or article (whether or not they cooperate) may alternatively be used in place of the single device, component or article that is described. Accordingly, the functionality that is described as being possessed by a device may alternatively be possessed by more than one device, component or article (whether or not they cooperate).

Similarly, where more than one device, component, structure, or article is described herein (whether or not they cooperate), a single device, component, structure, or article may alternatively be used in place of the more than one device, component, structure, or article that is described. For example, a plurality of computer-based devices may be substituted with a single computer-based device. Accordingly, the various functionality that is described as being possessed by more than one device, component, structure, or article may alternatively be possessed by a single device, component, structure, or article.

The functionality and/or the features of a single device that is described may be alternatively embodied by one or more other devices that are described but are not explicitly described as having such functionality and/or features. Thus, other embodiments need not include the described device itself, but rather can include the one or more other devices which would, in those other embodiments, have such functionality/features.

Further, the systems and methods described herein are not limited to the specific embodiments described herein but, rather, operations of the methods and/or components of the system and/or apparatus may be utilized independently and separately from other operations and/or components described herein. Further, the described operations and/or components may also be defined in, or used in combination with, other systems, methods, and/or apparatus, and are not limited to practice with only the systems, methods, and storage media as described herein.

Devices that are in communication with each other need not be in continuous communication with each other, unless expressly specified otherwise. On the contrary, such devices need only transmit to each other as necessary or desirable, and they may actually refrain from exchanging data most of the time. For example, a machine in communication with another machine via the Internet may not transmit data to the other machine for weeks at a time. In addition, devices that are in communication with each other may communicate directly or indirectly through one or more intermediaries.

A description of an embodiment with several components or features does not imply that all or even any of such components and/or features are required. On the contrary, a variety of optional components are described to illustrate the wide variety of possible embodiments of the innovations described herein. Unless otherwise specified explicitly, no component and/or feature is essential or required.

Further, although process steps, algorithms or the like may be described in a sequential order, such processes may be configured to work in different orders. In other words, any sequence or order of steps that may be explicitly described does not necessarily indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the innovations described herein, and does not imply that the illustrated process is preferred.

Although a process may be described as including a plurality of steps, that does not indicate that all or even any of the steps are essential or required. Various other embodiments within the scope of the present disclosure include other processes that omit some or all of the described steps. Unless otherwise specified explicitly, no step is essential or required.

Although a product may be described as including a plurality of components, aspects, qualities, characteristics and/or features, that does not indicate that all of the plurality are essential or required. Various other embodiments within the scope of the present disclosure include other products that omit some or all of the described plurality.

An enumerated list of items (which may or may not be numbered) does not imply that any or all of the items are mutually exclusive, unless expressly specified otherwise. Likewise, an enumerated list of items (which may or may not be numbered) does not imply that any or all of the items are comprehensive of any category, unless expressly specified otherwise. For example, the enumerated list “a computer, a laptop, a PDA” does not imply that any or all of the three items of that list are mutually exclusive and does not imply that any or all of the three items of that list are comprehensive of any category.

Headings of sections provided in this disclosure are for convenience only and are not to be taken as limiting the disclosure in any way.

For the sake of presentation, the detailed description uses terms like “determine” and “select” to describe computer operations in a computer system. These terms denote operations performed by a computer and should not be confused with acts performed by a human being. The actual computer operations corresponding to these terms vary depending on implementation. For example, “determining” something can be performed in a variety of manners, and therefore the term “determining” (and like terms) can indicate calculating, computing, deriving, looking up (e.g., in a table, database or data structure), ascertaining, recognizing, and the like.

As used herein, the term “send” denotes any way of conveying information from one component to another component, and the term “receive” denotes any way of getting information at one component from another component. The two components can be part of the same computer system or different computer systems. The information can be passed by value (e.g., as a parameter of a message or function call) or passed by reference (e.g., in a buffer). Depending on context, the information can be communicated directly between the two components or be conveyed through one or more intermediate components. As used herein, the term “connected” denotes an operable communication link between two components, which can be part of the same computer system or different computer systems. The operable communication link can be a wired or wireless network connection, which can be direct or pass through one or more intermediate components (e.g., of a network). Communication among computers and devices may be encrypted to ensure privacy and prevent fraud in any of a variety of ways well known in the art.

It will be readily apparent that the various methods and algorithms described herein may be implemented by, e.g., appropriately programmed general-purpose computers and computing devices. Typically, a processor (e.g., one or more microprocessors) will receive instructions from a memory or like device, and execute those instructions, thereby performing one or more processes defined by those instructions. Further, programs that implement such methods and algorithms may be stored and transmitted using a variety of media (e.g., computer readable media) in a number of manners. In some embodiments, hard-wired circuitry or custom hardware may be used in place of, or in combination with, software instructions for implementation of the processes of various embodiments. Thus, embodiments are not limited to any specific combination of hardware and software. Accordingly, a description of a process likewise describes at least one apparatus for performing the process, and likewise describes at least one computer-readable medium for performing the process. The apparatus that performs the process can include components and devices (e.g., a processor, input and output devices) appropriate to perform the process. A computer-readable medium can store program elements appropriate to perform the method.

The term “computer-readable medium” refers to any non-transitory storage or memory that may store computer-executable instructions or other data in a computer system and be read by a processor in the computer system. A computer-readable medium may take many forms, including but not limited to non-volatile storage or memory (such as optical or magnetic disk media, a solid-state drive, a flash drive, PROM, EPROM, and other persistent memory) and volatile memory (such as DRAM). The term “computer-readable media” excludes signals, waves, and wave forms or other intangible or transitory media that may nevertheless be readable by a computer.

The present disclosure provides, to one of ordinary skill in the art, an enabling description of several embodiments and/or innovations. Some of these embodiments and/or innovations may not be claimed in the present application, but they may nevertheless be claimed in one or more continuing applications that claim the benefit of priority of the present application. Applicants may file additional applications to pursue patents for subject matter that has been disclosed and enabled but not claimed in the present application.

The foregoing description discloses only exemplary embodiments of the present disclosure. Modifications of the above disclosed apparatus and methods which fall within the scope of the present disclosure will be readily apparent to those of ordinary skill in the art. For example, although the examples discussed above are illustrated for a gaming market, embodiments of the present disclosure can be implemented for other markets. The gaming system environment of the examples is not intended to suggest any limitation as to the scope of use or functionality of any aspect of the disclosure.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

While the disclosure has been described with respect to the figures, it will be appreciated that many modifications and changes may be made by those skilled in the art without departing from the spirit of the disclosure. Any variation and derivation from the above description and figures are included in the scope of the present disclosure as defined by the claims.

What is claimed is:

1. An electronic gaming device comprising:
a display device;
an input device operable to receive player input; and
a game controller having at least one processor and a memory storing instructions, which, when executed, cause the at least one processor to:
determine a base game outcome in a base game window;
control the display device to present the base game outcome in the base game window;
in response to the base game outcome, determine whether a trigger condition exists;
in response to determining that the trigger condition exists, select a plurality of reel strips for a bonus reel spin, wherein each of the plurality of reel strips include one or more credit symbols;
determine an outcome of the bonus reel spin using a first weight table;
control the display device to present the outcome of the bonus reel spin;
select a second weight table based on a combination of credit symbols that are in the outcome of the bonus reel spin;
determine, using the second weight table, if one or more free games features should be triggered; and
in response to determining that one or more free games features should be triggered, control the display device to trigger the one or more free games features.

2. The electronic gaming device of claim 1, wherein each of the one or more credit symbols is assigned a color and a prize value, wherein the color corresponds to at least one metamorphic graphical element.

3. The electronic gaming device of claim 1, wherein the at least one processor further causes the at least one processor to:
control the display device to present a plurality of metamorphic graphical elements; and
control the display device to animate the plurality of metamorphic graphical elements, wherein the plurality of metamorphic graphical elements are animated based on the outcome of the bonus reel spin.

4. The electronic gaming device of claim 3, wherein each of the plurality of metamorphic graphical elements corresponds to one of the one or more free games features.

5. The electronic gaming device of claim 1, wherein the one or more free games features include an expand feature, a jackpot feature, a repeat feature, or a combination thereof.

6. The electronic gaming device of claim 1, wherein the outcome of the bonus reel spin is determined using a random number generator outcome.

7. The electronic gaming device of claim 1, wherein if one or more free games features should be triggered is determined using a random number generator outcome.

8. A computer-implemented method, comprising:
determining a base game outcome in a base game window;
causing a display device to present the base game outcome in the base game window;
in response to the base game outcome, determining whether a trigger condition exists;
in response to determining that the trigger condition exists, selecting a plurality of reel strips for a bonus reel spin, wherein each of the plurality of reel strips include one or more credit symbols;
determining an outcome of the bonus reel spin using a first weight table;
causing the display device to present the outcome of the bonus reel spin;
selecting a second weight table based on a combination of credit symbols that are in the outcome of the bonus reel spin;
determining, using the second weight table, if one or more free games features should be triggered; and
in response to determining that one or more free games features should be triggered, triggering the one or more free games features.

9. The computer-implemented method of claim 8, wherein each of the one or more credit symbols is assigned a color and a prize value, wherein the color corresponds to at least one metamorphic graphical element.

10. The computer-implemented method of claim 8, further comprising:
causing the display device to present a plurality of metamorphic graphical elements; and
causing the display device to animate the plurality of metamorphic graphical elements, wherein the plurality of metamorphic graphical elements are animated based on the outcome of the bonus reel spin.

11. The computer-implemented method of claim 8, wherein each of the plurality of metamorphic graphical elements corresponds to one of the one or more free games features.

12. The computer-implemented method of claim 8, wherein the one or more free games features include an expand feature, a jackpot feature, a repeat feature, or a combination thereof.

13. The computer-implemented method of claim 8, wherein the outcome of the bonus reel spin is determined using a random number generator outcome.

14. The computer-implemented method of claim 8, wherein if one or more free games features should be triggered is determined using a random number generator outcome.

15. A system, comprising:
one or more processors;
memory; and
control logic, implemented using the one or more processors and memory, configured to perform operations, comprising:
determining a base game outcome in a base game window;
causing a display device to present the base game outcome in the base game window;
in response to the base game outcome, determining whether a trigger condition exists;
in response to determining that the trigger condition exists, selecting a plurality of reel strips for a bonus reel spin, wherein each of the plurality of reel strips include one or more credit symbols;
determining an outcome of the bonus reel spin using a first weight table;
causing the display device to present the outcome of the bonus reel spin;
selecting a second weight table based on a combination of credit symbols that are in the outcome of the bonus reel spin;
determining, using the second weight table, if one or more free games features should be triggered; and
in response to determining that one or more free games features should be triggered, triggering the one or more free games features.

16. The system of claim 15, wherein each of the one or more credit symbols is assigned a color and a prize value, wherein the color corresponds to at least one metamorphic graphical element.

17. The system of claim 15, wherein the control logic is further configured to perform operations comprising:
causing the display device to present a plurality of metamorphic graphical elements; and
causing the display device to animate the plurality of metamorphic graphical elements, wherein the plurality of metamorphic graphical elements are animated based on the outcome of the bonus reel spin.

18. The system of claim 15, wherein each of the plurality of metamorphic graphical elements corresponds to one of the one or more free games features.

19. The system of claim 15, wherein the one or more free games features include an expand feature, a jackpot feature, a repeat feature, or a combination thereof.

20. The system of claim 15, wherein the outcome of the bonus reel spin is determined using a random number generator outcome.
